(19) United States
(12) Patent Application Publication
(10) Pub. No.: US 2023/0140751 A1
(43) Pub. Date: May 4, 2023

(54) CONNECTED BREWING MACHINE WITH SHARED BREWING RECIPES

(71) Applicant: SPINN HOLDING B.V., Amsterdam (NL)

(72) Inventors: Serge Alfred Johan de Warrimont, Amsterdam (NL); Roderick de Rode, Amsterdam (NL); Wouter Beeftink, Pannerdam (NL); Luuk Steitner, Vianen (NL); Daan Oostveen, Haarlem (NL)

(73) Assignee: SPINN HOLDING B.V., Amsterdam (NL)

(21) Appl. No.: 17/515,939

(22) Filed: Nov. 1, 2021

(51) Int. Cl. A47J 31/52; A47J 31/60; A47J 31/42

(52) U.S. Cl. CPC A47J 31/5253; A47J 31/60; A47J 31/42

(57) ABSTRACT

In an embodiment, a roaster application may be provided. The roaster application may allow a roaster to create and customize coffee recipes. The roaster application may upload the recipes to a back-end server. Connected coffee machines may download the recipes and use the brew parameters in the downloaded recipes to more precisely replicate the roaster's recipe. In another embodiment, a hot brew coffee machine may be used to generate cold brew coffee. For example, a mechanical actuator such as centrifugal brewer assembly may be used to create a cold brew temperature in the coffee machine. The centrifugal brewer assembly may pull hot air out of the brewer assembly until the coffee machine reaches the desired cold brew temperature. Alternatively or additionally, cold water may be sprayed to the brewing mechanism to reach the desired cold brew temperature.

### RELATED APPLICATIONS

This application is related to U.S. Pat. Nos. 8,039,033, 10,863,855, and U.S. patent application Ser. No. 16/636,841, all of which are incorporated herein by reference.

### BACKGROUND

Specialty coffee making is a subtle art. A careful fine-tuning of one or more different types of parameters such as coffee grind, brewing temperature, amount of coffee, amount of water, brewing time, etc. is required to get a desired taste. Furthermore, coffee roasters may create recipes based on, for example, the type of coffee beans, the roast, and the roasters' own experience. However, it is difficult to recreate these recipes at a home or commercial environment because users (i) may have different types of coffee machines with different types of configurable parameters, and (ii) lack the knowledge/expertise to adjust parameters based on, for example, the bean and/or roast. Therefore, there is a gap between a roaster's recipe and the coffee brewed by individual coffee machines at homes (or at businesses).

### BRIEF DESCRIPTION OF DRAWINGS

Other objects and advantages of the present disclosure will become apparent to those skilled in the art upon reading the following detailed description of exemplary embodiments and appended claims, in conjunction with the accompanying drawings, in which like reference numerals have been used to designate like elements, and in which:

FIG. 1 shows an illustrative network environment, according to an example embodiment of the present disclosure.

FIGS. 2A-2D show several views of an illustrative brew machine, according to an example embodiment of the present disclosure;

FIG. 3 shows an illustrative interface on a brew machine, according to an example embodiment of the present disclosure;

FIG. 4 shows an illustrative architecture of a brew machine, according to an example embodiment of the present disclosure;

FIGS. 5A-5C show illustrative interfaces generated by an application executing on a user computing device, according to an example embodiment of the present disclosure;

FIG. 6 shows a flow diagram of an illustrative method of brewing a selected drink, according to an example embodiment of the present disclosure;

FIGS. 7A-7B shows illustrative process diagrams of generating cooling conditions in the brew machine;

FIG. 8 shows a flow chart of illustrative method of generating and updating drink recipes, according to an example embodiment of the present disclosure;

FIGS. 9A-9B show illustrative interfaces generated by a roaster application for entering roast parameters, according to an example embodiment of the present disclosure;

FIGS. 10A-10C show illustrative interfaces generated by a roaster application for customizing a drink recipe, according to an example embodiment of the present disclosure;

FIG. 11 shows a flow diagram of an illustrative method of calibrating coffee bean grinding, according to an example embodiment of the present disclosure;

FIG. 12 shows an illustrative architecture of a processing device, according to an example embodiment of the present disclosure; and

FIGS. 13A-13D shows illustrative process diagrams of brewing in the brew machine.

The figures are for purposes of illustrating example embodiments, but it is understood that the present disclosure is not limited to the arrangements and instrumentality shown in the drawings. In the figures, identical reference numbers identify at least generally similar elements.

### DETAILED DESCRIPTION

Wired and/or wireless networks can be used to connect brew machines (e.g., coffee machines) with devices to enhance the brewing experience. Certain examples provide automatic configuration of drink recipes (including, for example, brewing parameters targeted to a specific machine) on a connected brew machine upon selection of a coffee or tea that is to be used with a brew machine. Recipes can be generated by remote experts (e.g., specialty coffee roasters, baristas, etc.) and downloaded to a connected brew machine for a brew to be optimized (e.g., for the bean, roast, drink selected, etc.) for a specific bean and/or roast as well as the brewing machine to produce a consistent (or nearly consistent) beverage.

Certain embodiments include a new roaster application (e.g., configured to be executed by a processing device) that allows a roaster (or otherwise recipe creator) to create and customize brew recipes (e.g., coffee/tea drink recipes tailored to a specific brew machine or a type of brew machine) that can be accessed by connected brew machines and/or connected grinder machines. In some embodiments, the roaster application may transmit the recipes to a connected brew machine and/or to a connected server so that other devices (e.g., connected brew machines, processing devices, etc.) can access the recipes. In some embodiments, the roaster application may instruct a connected brew machine to upload the recipes to a server so that other devices (e.g., connected brew machines, processing devices, etc.) can access the recipes. In other embodiments, the connected brew machine may provide the recipes directly to other devices (e.g., connected brew machines, processing devices, etc.) so they can access the recipes.

In some embodiments, the roaster application, which may execute on a processing device, provides an interface for the roaster (or otherwise recipe creator) to interact with a brew machine, a grinder machine and/or a connected server. For example, a communication may be established between the roaster application and the brew machine (and/or the grinder machine) through the server (although a direct, local communication between the roaster application and the brew machine is also considered within the scope of this disclosure). To generate a coffee recipe, for example, the roaster application provides an interface for the roaster (or otherwise recipe creator) to enter one or more parameters associated with the coffee beans (e.g., type, color, roast level, etc.). In some embodiments, once the beans are in a hopper that is associated with the brew machine, the brew machine may perform a grind calibration using, for example, a two-stage process. In the first grinding stage, the brew machine initiates grinding of the beans using a default calibration grind setting (e.g., a grind setting established at the factory) that can be used to characterize the beans with respect to a reference bean that was used for initial calibration (e.g., a reference bean used at the factory with a grind setting established at the factory). The beans are then evaluated to determine one or more parameters associated with the first grinding stage. For example, one parameter may be the amount (e.g., weight) of ground beans produced during the first grinding stage. The one or more parameters for the first grinding stage may be uploaded, by the roasting app, the brew machine, and/or the grinder machine, to the server and used to determine one or more initial brew parameters for the recipe associated with the beans. In the second grinding stage, the brew machine (and/or the grinder machine) initiates grinding of the beans until an amount of ground coffee in the brewer assembly is maximized (e.g., as measured by a sensor in the brew machine or the grinder machine). This may be used to determine, for these beans, the maximum amount of beans that can be input into the machine. This can be reflected, for example, as a parameter limit in a user interface for customizing drink recipes with these beans. The initial brew parameters for the recipe may be updated to reflect additional information gathered from the second grinding stage. The roaster (or otherwise recipe creator) can modify the recipes, e.g., by using sliders or other tools in a graphical user interface (GUI), to further customize the recipes to the roaster's particular taste and/or preference. Once modified, the recipes may be stored by the server and associated with the roaster and/or bean type for connected brew machines to download and replicate the recipes.

In some embodiments, a connected brew machine may be connected via a wired or wireless data network to the server to access and download the recipes. The brew machine may include an interface for a user to select a drink recipe such as, for example, an americano, an espresso, a hot tea, a cold brew, etc. Once a recipe is selected, the brew machine can start brewing the drink. In some examples, when a drink recipe is selected, the brew machine downloads the recipe from the server, adjusts the brew parameters according to the recipe, and starts brewing the drink. Some example brew parameters include, amount of coffee to be used, grind size, amount of water to be used, ratio of coffee to water, soak time of the coffee grounds, coffee cake density, target brew temperature, etc.

Certain embodiments include a brewer application that allows a user to interact with the brew machine to select the bean type, customize recipes, and create drinks, among other things. For example, a communication may be established between the brewer application and the brew machine through a server (although a direct, local communication between the brewer application and the brew machine is also considered within the scope of this disclosure). The brewer application may present a user interface (e.g., GUI, voice interface, etc.) for interacting with the brew machine. The user interface may include multiple sliders, buttons, selectable objects, etc. such that interacting with the sliders, buttons, selectable objects, etc. may enable a user to customize drink recipes by adjusting brew parameters. Additionally, the brewer application may be used by the user to provide feedback on, for example, drink selections, customized parameters, etc. that can be accessed by the roasters (or otherwise recipe creators) to better understand how users are using their beans and/or recipes. The feedback may also include user input such as, for example, “thumbs up/thumbs down,” “burnt taste,” “too watery,” “too tepid,” etc. The feedback may be used, for example, to automatically modify a recipe (e.g., if the feedback is consistent for one particular brew parameter, that parameter may be automatically modified), and/or to provide feedback to the roasters (or otherwise recipe creators). Therefore, two-way communication may be established between the roasters (or otherwise recipe creators) and the users to share and fine tune different coffee recipes.

Embodiments disclosed herein allow developing hot and cold brew drinks in a single connected brew machine, while conventional brewing devices may be inadequate for that purpose. Conventionally, two separate brewing devices are maintained for hot brew and cold brew beverages because of the competing requirements of cooling and heating mechanisms. A separate cold brew device may include cooling components (e.g., heat exchangers) to get to a cold brew temperature. Because the heating and cooling generally involve separate, non-compatible technologies; the conventional practice has been therefore to maintain two different devices. The embodiments disclosed herein attempt to overcome these and other shortcomings of conventional brewing devices.

In an embodiment, a single brew machine may be used to generate both hot brew and cold brew beverages. For example, in a hot brew mode, heating elements are typically enabled to heat the different brewing components to a target hot brew temperature. Alternatively, in a cold brew mode, it is desirable to cool the brewing components to a target cold brew temperature that is less than the target hot brew temperature. For the cold brew mode, the heating elements may be disabled and different mechanisms (e.g., mechanical actuation) may be used for the brewing components to meet a target cold brew temperature. For example, a centrifugal brewer assembly may be rotated at a high rpm (revolutions per minute) before adding coffee grinds to the brewer assembly to pull hot air away from the brew machine and cool the brewing components. Additionally or alternatively, cold water may be run through the brewing components prior to brewing to cool the brew components to a target cold brew temperature. In some environments, cooling the brew components may involve cooling the cold water through mechanisms such as ice cubes placed in the water tank, etc. to reach the desired temperature. The switching between the hot brew and cold brew modes introduces new design challenges for a single brew machine (e.g., single centrifugal brewer, single water reservoir, etc.). For instance, to achieve such switching between hot and cold brew modes, heaters may be turned on (or enabled) for the hot brew mode and turned off (or disabled) for the cold brew mode, concomitantly with other cooling mechanisms such as, for example, blowing or pulling air through the machine and/or spraying cold water onto components to help cool them down.

Combining a hot brew mode and cold brew mode introduces additional design considerations. For example, a hot brew machine can automatically implement cleaning procedures to eliminate bacteria and mold from forming in the machine by heating the machine to temperatures that may kill bacteria and sanitize the machine. However, these procedures oppose the cold temperature that may be used by a cold brew machine. In some embodiments, the brew machine may provide a cleaning mode that works for both hot brew and cold brew modes. For example, a cleaning mode (e.g., to preempt bacteria and mold growth in the brew machine due to the cold brew process) may include heating components in the brewer and passing hot water through the system and out through a drain. However, consideration must be made when these procedures are enacted to avoid unnecessarily heating a brew machine that is being used for brewing cold brew beverages. The cleaning procedures may be invoked after a timer duration to avoid unnecessarily heating the machine when making several cold brew drinks. For example, a timer may be set such that the duration is a pre-determined time value since the last beverage was brewed.

In an embodiment, a beverage machine configured to selectively operate in a brew mode selected from a hot brew mode and a cold brew mode is provided. The beverage machine may include a temperature sensor; a brewing component; a processor; and a tangible, non-transitory computer readable medium storing computer program instructions, that when executed by the processor, cause the beverage machine to perform operations, in the cold brew mode, comprising: detecting, via the temperature sensor, a temperature of the brewing component; determining that the temperature is above a cold brew target temperature; causing a fluid circulation adjacent to the brewing component until the temperature reaches the cold brew target temperature; and after the temperature reaches the cold brew target temperature, cold brewing a beverage using the brewing component at the cold brew target temperature.

In another embodiment, a computer implemented method is provided. The method may include receiving, by a computing device, at least one roast parameter of coffee beans to be processed at a first brewing machine, the first brewing machine includes a grinding process to grind coffee beans for brewing; transmitting, by the computing device, the received at least one roast parameter to the first brewing machine; receiving, by the computing device, at least one grinder parameter for the coffee beans, the at least one grinder parameter being generated by the first brewing machine based on one or more grinding cycles; displaying, by the computing device in a graphical user interface, at least one customizable recipe parameter for a drink associated with the coffee beans, the at least one customizable recipe parameter based on the at least one grinder parameter; receiving, by the computing device through the graphical user interface, an adjustment to the customizable recipe parameters; generating, by the computing device, a recipe for the drink, the recipe based on the adjustment to the at least one customizable recipe parameter; transmitting, by the computing device, the recipe for the drink to a second brewing machine; and instructing, by the computing device, the second brewing machine to brew the drink.

In another embodiment, a system is provided. The system may include a temperature sensor; a brewing component configured to selectively operate in a brew mode selected from a hot brew mode and a cold brew mode; a processor; and a tangible, non-transitory computer readable medium storing computer program instructions, that when executed by the processor, cause the system to perform operations, in the cold brew mode, comprising: detecting, via the temperature sensor, a temperature of the brewing component; determining that the temperature is above a cold brew target temperature; causing a fluid circulation adjacent to the brewing component until the temperature reaches the cold brew target temperature; and after the temperature reaches the cold brew target temperature, cold brewing a beverage using the brewing component at the cold brew target temperature. The system may further include a grinder machine configured to grind beans for the beverage responsive to receiving a message from the processor.

In yet another embodiment, a method implemented on a beverage machine is provided. The method may include in a cold brew mode, selected from a hot brew mode and the cold brew mode: detecting, via a temperature sensor of the beverage machine, a temperature of a brewing component of the beverage machine; determining that the temperature is above a cold brew target temperature; causing a fluid circulation adjacent to the brewing component until the temperature reaches the cold brew target temperature; and after the temperature reaches the cold brew target temperature, cold brewing a beverage using the brewing component at the cold brew target temperature.

These are all but a few technical advantages of the several embodiments described herein. Other advantages may be apparent upon reading of the detailed description and related drawings. Furthermore, it should also be understood that although the examples described herein pertain to coffee machines and specific reference to coffee is described, these examples may apply to other beverages as well, such as tea or other brewed drinks. It should also be understood that examples described herein reference a roaster and/or roaster app, these examples may apply to other users that desire to share drink recipes and are not limited to roasters.

While some examples described herein may refer to functions performed by given actors such as “users” and/or other entities, it should be understood that this is for purposes of explanation only. The claims should not be interpreted to require action by any such example actor unless explicitly required by the language of the claims itself

1. Example Network Environment

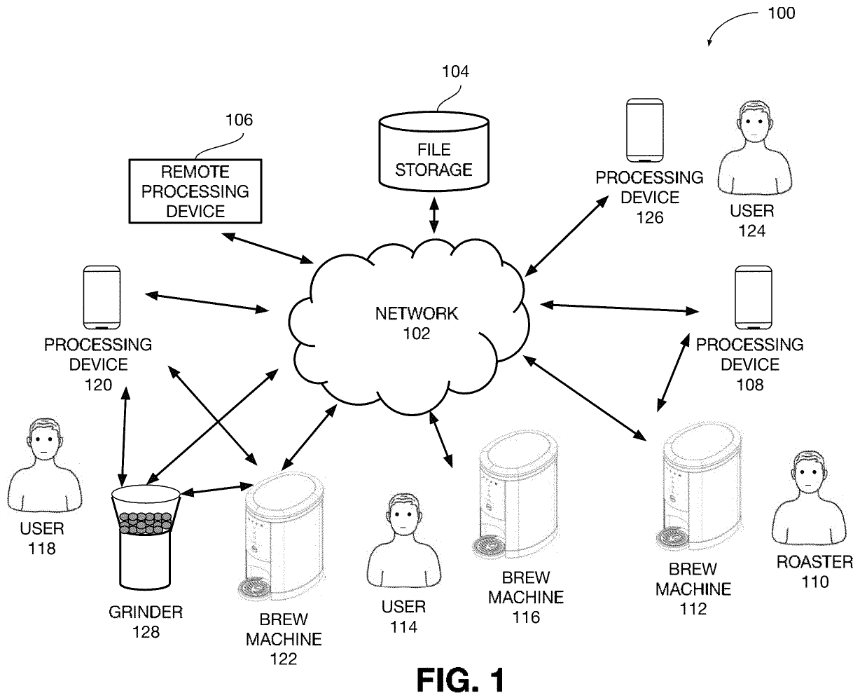

FIG. 1 illustrates an example network environment 100, according to an example embodiment of the present disclosure. As shown, the network environment 100 may include a network 102; a file storage 104; a remote processing device 106; brew machines 112, 116, and 122; grinder machine 128; users 114, 118, and 124; a roaster 110; and processing devices 108, 120, and 126. It should be understood that the devices shown in FIG. 1 and described herein are merely examples, and network environments with additional, alternate, fewer number of devices, or devices in other configurations should also be considered within the scope of this disclosure. For example, a connected grinder machine (e.g., grinder machine 128) may be used separately from connected brew machines.

The network 102 may include any type of network that may facilitate communication between devices of the network environment. The network 102 may include wired communication links, wireless communication links, and/or networking components such as switches, routers, and repeaters. It should therefore be generally understood that the network 102 may include a combination of a plurality of packet switching networks and/or a plurality of circuit switching networks. For instance, the network 102 may include local area network (LAN), metropolitan area network (MAN), and/or wide area network (WAN) such as the Internet.

The file storage 104 may include any type of database that may store files (e.g., recipe files, user/roaster information, bean information, brew machine information, etc.) and/or any other type of data in the network environment 100. The file storage 104 therefore should be understood as including hardware components (e.g., hard drives, solid state drives) and software components (e.g., data storage schemas). Although the file storage 104 is shown as a single device, it should be understood that the file storage 104 may represent multiple, geographically distributed devices. In other words, the file storage 104 may have multiple hardware and software components distributed throughout the network environment 100.

The remote processing device 106 may be any kind of computing device that may operate as a server for facilitating client-server relationships with the processing devices 108, 120, and 126, brew machines 112, 116 and 122, and/or grinder machine 128. Non-limiting examples of the remote processing device 106 may include server computing devices, desktop computing devices, laptop computing devices, mobile computing devices, and/or cloud computing devices. As with the file storage 104, the remote processing device 106 may represent multiple devices distributed throughout the network environment 100. At minimum, the remote processing device 106 may include a memory that may store computer program instructions and a processor coupled to the memory that may execute the computer program instructions to realize, at least partially, the functionality described herein.

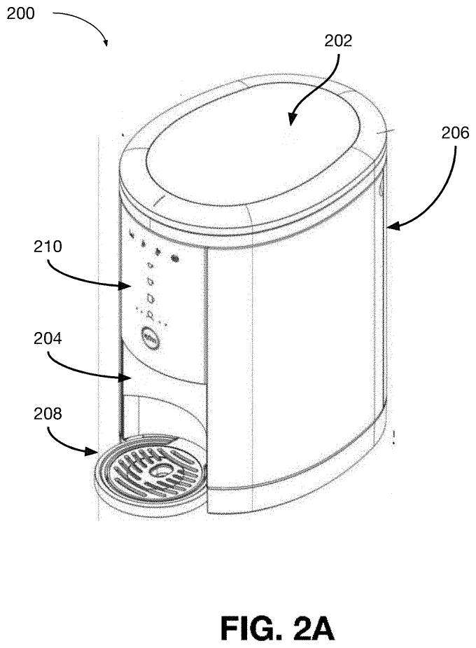

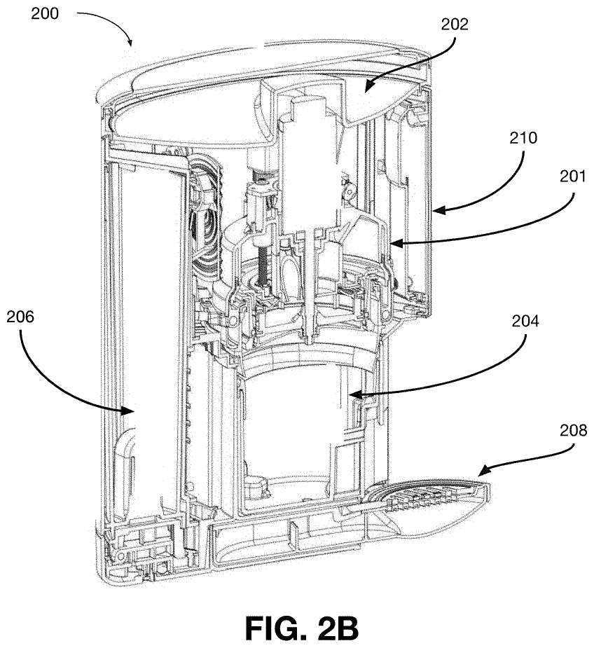

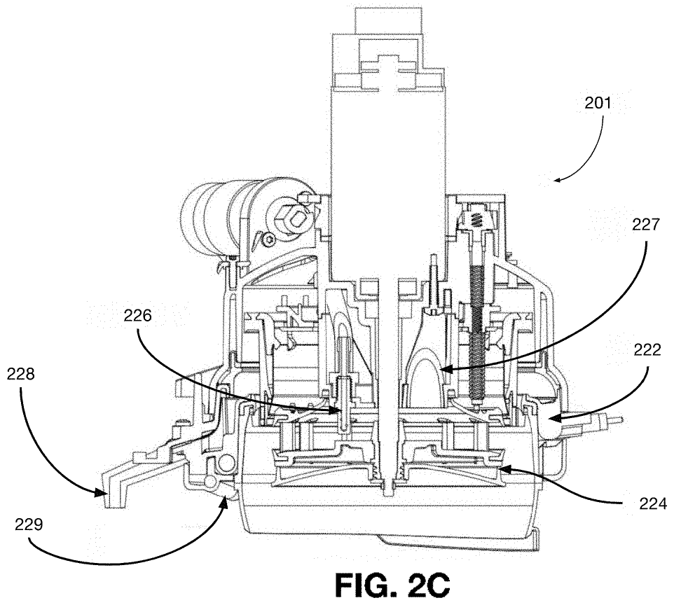

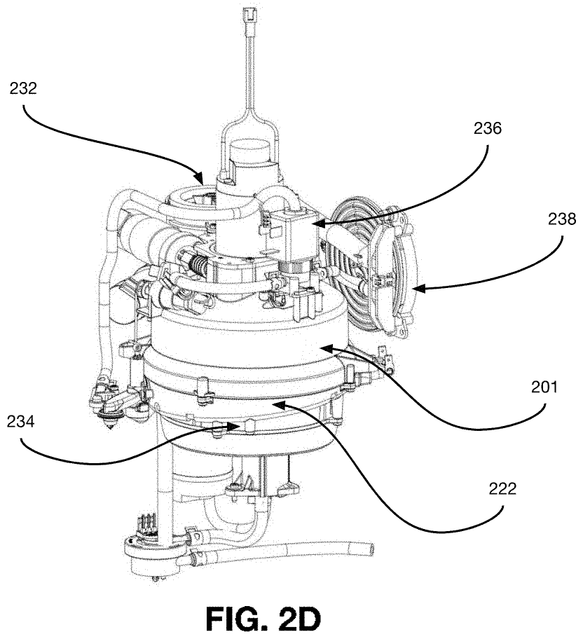

The brew machines 112, 116, and 122 may include any kind of brew machine that may generate a drink using a brewing process such as, for example, coffee machine, espresso machine, etc. An example brew machine is described below and shown in FIG. 2A-2D. Several other examples of brew machines are described in U.S. Pat. Nos. 8,039,033, 10,863,855, and U.S. patent application Ser. No. 16/636,841, all of which have been incorporated by reference in their entirety. In some cases, the brew machines 112, 116, and 122 may include a grinder functionality for grinding beans. The grinder machine 128 may be any kind of network connected grinder (e.g., burr grinder) that may grind coffee beans. The brew machine users 110, 114, 118, and 124 may be persons using the corresponding brew machines. For example, brew machine user 110 may be a roaster (or otherwise recipe creator) and brew machine users 114 and 118, and 124 may be consumers.

In the example network environment 100, the brew machine 112 may be used by a roaster 110. The roaster 110 may use the processing device 108 to interact with and control the brew machine 112. In some embodiments, the roaster 110 may use the processing device 108 to interact with and control a grinder machine. The processing device 108 may execute a roaster application assisting the roaster 110 to create and customize various drink recipes.

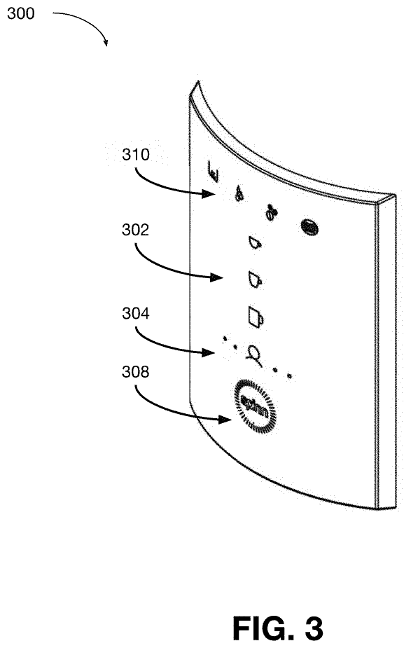

In the example network environment 100, the brew machines 116 and 122 may be used by users 114, 118, and 124. The users 114 and 118 may interact directly with the brew machines using an interface on the brew machine (see, for example, the user interface shown in FIG. 3). The users 118 and 124 may use processing devices 120 and 126, respectively, to interact with and control the brew machines 116 and 122. The processing devices 120 and 126 may execute a brewing application assisting the users 118 and 124 to download and customize the drink recipes created by the roaster 110. In some embodiments, the users 118 and 124 may interact with the grinder machine 128 using the processing devices 120 and 126, respectively. In some embodiments, the brew machine 122 may interact with the grinder machine 128 directly.

In operation, the roaster 110 may generate a recipe using the brew machine 112 and the roaster application running on the processing device 108. The brew machine 112 may generate, for example, for a particular bean and roast, drink recipes including parameters associated with the bean grind, ratio of coffee to water, etc. The roaster 110 may use the interface of the roaster application to determine the drink recipes. The drink recipes may be uploaded to the remote processing device 106, which may store the recipes in the file storage 104. Other brew machines 116 and 122 may download the stored recipes via the remote processing device 106 and implement the recipes.

2. Example Brew Machine

FIG. 2A illustrates a perspective view of a brew machine 200 that may be configured to be one or more of the brew machines 112, 116, 122 of the example network environment 100 of FIG. 1, according to an example embodiment of the present disclosure. As shown, the brew machine 200 may include a bean hopper 202, a ground residue container 204, a water reservoir tank 206, a drip tray 208, and an interface 210, among other functional elements. The brew machine 200 may include a centrifugal brewer assembly. U.S. Pat. Nos. 8,039,033, 10,863,855, and U.S. patent application Ser. No. 16/636,841, all of which are incorporated herein by reference, provides in more detail some non-limiting examples of centrifugal brew machines. Example brew machines include “Spinn Original,” “Spinn Original Plus,” and “Spinn Original Pro,” which are offered by Spinn, Inc. of the United States and/or Spinn Holding BV of The Netherlands.

FIG. 2B illustrates a perspective view of example internal components of the brew machine 200 according to an example embodiment of the present disclosure. More particularly, FIG. 2B shows a cross sectional view of the brew machine 200, with an internal perspective view of the components shown in FIG. 2A. In addition, FIG. 2B shows an internal view of a brewer assembly 201. FIG. 2C shows a cross sectional view of the brewer assembly 201 without including the housing. FIG. 2D depicts example internal components of the brew machine 200, according to an example embodiment of the present disclosure.

With regards to the example components shown in FIGS. 2A-2D, the bean hopper 202 may receive and hold beans (e.g., coffee beans) that are to be passed down to a grinder assembly 232 in preparation for a brew. Once the beans are ground, they are moved (e.g., using a conveyor in a bean transport tube 227 as described in U.S. patent application Ser. No. 16/636,841 which is incorporated herein by reference in its entirety) to the brew assembly for brewing. In some embodiments the brew machine may not include the bean hopper 202 and/or a grinder assembly 232, and instead accept pre-ground coffee (or tea) as input into the brew machine using an alternate input mechanism. The water reservoir tank 206 is used to hold water that is used for brewing, cleaning, heating, and cooling the machine. The water reservoir tank 206 may include one or more sensors (described below) to detect the level of water, the water temperature, water purity, etc. Water is transferred using a water line from the water reservoir tank 206 to a water inlet 226 where it enters the brewer 224. In some embodiments the brew machine may be plumbed directly into an external water line feeding water into the machine.

The hot or cold brew beverage is created by the brewing assembly 201 and delivered to an awaiting vessel (e.g., cup) via the spout 228. After the brewing is complete, the residue (e.g., coffee or tea) particles are expelled from the brewer 224 into the residue container 204. The drip tray 208 is used to catch any excess liquid generated when the brewed drink is being dispensed. The drip tray 208 is also used to catch other fluids, e.g., cold/hot water used for cooling/heating the brew machine 200 and/or hot water used for cleansing the brew machine 200. In some embodiments, sensors are used on and/or around the drip tray to detect that a vessel (e.g., cup) is present for brewing and avoid starting a brew if a vessel is not present. For example, a pressure sensor may be used to determine if a vessel is placed on the drip tray. The interface 210 may allow a user to communicate with the brew machine, for example, to select a drink to be brewed, start a brew, etc. The interface 210 may also provide a status indication of a drink and/or of the brew machine 200. The brewer assembly 201 may include components that may receive ground beans and water to generate a drink through any kind of brewing mechanism, e.g., centrifugal brewing.

FIG. 2C depicts example internal components of the brewer assembly 201 comprising a gutter heating element 222 (also referred to as a ring heater), a brewer 224, a water inlet 226, a transport tube 227, a spout 228, a drain 229, among other parts. The gutter heating element 222 wraps around the brewer 224 and is used to heat the brewed beverage as it makes its way from the brewer 224 to the spout 228 for delivery to an awaiting vessel. The brewer 224 may include a spinning assembly with a brewing chamber and filter, among other components as described in U.S. patent application Ser. No. 16/636,841 which is incorporated herein by reference in its entirety. The brewer 224 combines water and ground particles under pressure (e.g., spinning a centrifugal brewer at a relatively high rotational speed) to brew a beverage. The water inlet 226 is used to inject water into the brewer 224. The transport tube 227 provides ground particles (e.g., beans) to the brewer 224. The spout 228 is used to deliver the brewed drink to a vessel (e.g., a coffee cup) below. The drain 229 may deliver other fluids, e.g., cold/hot water for cooling/heating the brewing assembly 201 or hot water for cleansing the brewing assembly 201 to a drainage component (e.g., drip tray 208).

FIG. 2D depicts internal components of the example brew machine 200, including a grinder assembly 232, one or more temperature sensors 234, a gutter heating element 222, the brewer assembly 201, a solenoid valve 236, and a water heating element 238 (also referred to as water heater). The grinder assembly 232 may include an actuation mechanism (e.g., a motor) that may grind beans from the bean hopper 202. The grinder may include an inner and outer burr that are rotatable relative to one another about a main grinder axis. The position of the inner burr may be adjustable (e.g., based on a signal provided to a corresponding controller) while the outer burr may be fixed. The adjustment of the position of the burrs may be done to generate a desired coarseness of the ground. The coarseness (and/or adjustment amount) may be part of (or determined from) a drink recipe that is provided to the brew machine (e.g., downloaded from a server, received from another brew machine, received from a processing device associated with a brewing application, received from a processing device associated with a roaster application, etc.). The one or more temperature sensors 234 may comprise any kind of temperature sensing mechanism that may detect the temperature of the brewer assembly 201. The solenoid valve 236 may include an actuation mechanism that may open and close a corresponding valve. For instance, the solenoid valve 236 may open and close allowing for water (either heated or cold) to be conveyed to the brewer assembly 201. The water heating element 238 may include any kind of heating mechanism that may heat water received from the water reservoir tank 206 (or plumbed water line) after which the water may be provided to the brewer assembly 201 through the water inlet 226. For example, a thin film heating element may be used to rapidly heat water. The benefit of using a thin film heating element (e.g., constructed with low mass) in a brew machine that provides both hot and cold brew beverages is that it can quickly switch between providing hot and cold water without requiring significant time to cool down the heating element, unlike a boiler or heating block that is typically used in a brew machine. This is because thin film heating elements typically have low mass and only contain a small volume of water compared to the larger mass of a heating block and/or larger volume of water stored in a boiler. Alternatively and/or additionally, water may be provided directly to the brewer assembly 201 for a cold brew process by bypassing the water heating element altogether with a configurable switch.

The aforementioned description includes a few examples of components of a brew machine 200. Additional, alternate, or fewer number of components should also be considered within the scope of this disclosure.

FIG. 3 illustrates an example interface 300 of a brew machine (e.g., brew machine 200) according to an example embodiment of the present disclosure. As shown, the interface 300 may comprise various selectable items (e.g., using capacitive buttons, etc.) and indicators (e.g., screen printed partially-transparent images with LED backlight, etc.) that may be used to operate the coffee machine. A first set of selectable items 302 may correspond to a set of recipes associated with a set of drinks (e.g., standard drinks) and may visually depict the types of the drinks. For example, the first set of selectable items 302 depicted in FIG. 3 show an espresso, a doppio, and a drip cup (e.g., with relative sizes) corresponding to a set of recipes for the brew machine associated with an espresso, a doppio, and a drip cup of coffee, respectively. A second set of selectable items 304 may be configured by the user corresponding to recipes and/or other functionality associated with the brew machine. For example, the second set of selectable items 304 depicted in FIG. 3 as four dots may be configured via a software application (e.g., brewing application, roaster application, etc.) executing on a processing device such as, for example, processing device 108, 120, 126 of FIG. 1. A third selectable item 308 may be used to initiate the selected brew functionality and provide an indication of the brewing status. For example, the third selectable item 308 depicted in FIG. 3 may initiate (e.g., based on user selection) a selected brew process (e.g., hot brew and/or cold brew) and indicate (e.g., via colored LEDs) the status of the brew. A set of indicators 310 may be used to communicate the status of the brew machine. For example, the set of indicators 310 depicted in FIG. 3 convey the status of a ground residue container (e.g., ground residue container 204), water reservoir tank (e.g., water reservoir tank 206), bean hopper (e.g., bean hopper 202), and a drip tray (e.g., drip tray 208).

Although FIG. 3 shows the interface 300 with selectable capacitive buttons with backlit LEDs, it should be understood that other forms of interfaces should also be considered within the scope of this disclosure. For instance, the interface 300 may alternatively or additionally include a touch screen, dials, any type of capacitive touch sensors, microphone for voice input, and/or any other type of input mechanism for configuring the functionality of the brew machine.

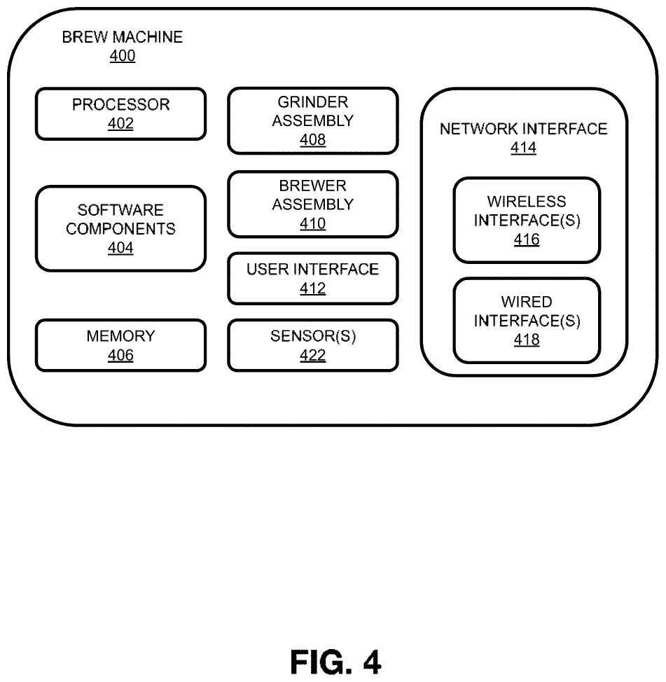

FIG. 4 illustrates a functional block diagram of an example brew machine 400 (which may be, for example, similar/identical to the brew machine 200) that may be configured to be one or more of the brew machines 112, 116, and 122 of the example network environment 100 of FIG. 1. The brew machine 400 may include a processor 402, software components 404, memory 406, a grinder assembly 408, a brewer assembly 410, a network interface 414 including wireless interface(s) 416 and wired interface(s) 418, user interface 412, and sensor(s) 422. It should be understood that any of the block of components identified here need not necessarily be bodily incorporated into a single physical device, and could instead be interconnected via a wired or wireless network. For example, the brewer assembly 410 and grinder assembly 408 may be in separate physical devices.

In one example, the processor 402 may be a clock-driven computing component configured to process input data according to instructions stored in the memory 406. The memory 406 may be a tangible computer-readable medium configured to store instructions executable by the processor 402. For instance, the memory 406 may be data storage that can be loaded with one or more of the software components 404 executable by the processor 402 to achieve certain functions, e.g., the several functions disclosed herein. In one example, the functions may involve the brew machine 400 retrieving data (e.g., recipes, bean/roast information, user information, etc.) from a server, a processing device, and/or another brewing machine. In another example, the functions may involve the brew machine 400 sending data (e.g., recipes, usage data, etc.) to a server, a processing device, and/or another brewing machine. In yet another example, the functions may involve pairing of the brew machine 400 with one or more other network connected devices (e.g., an external grinder, an external milk frothing device, etc.).

In some examples, specialized processor hardware and/or specialized software modules may be used to support voice interactions/experiences with the brew machine. Voice capture (e.g., microphone) and response (e.g., speaker) are supported within the architecture of the brew machine within the block's sensor(s) 422 and user interface 412. Additionally, voice detection and/or user intent may be processed locally on the brew machine using processor 402 and software components 404 and/or transmitted/received over the network interface 414 to/from a remote processing device for remote processing.

The memory 406 may further be configured to store data associated with the brew machine 400, such as user information, recipe information, bean/roast information, etc. The data may be stored as one or more state variables that are periodically updated and used to describe the state of the brew machine 400. The memory 406 may also include the data associated with the state of the other devices (e.g., a second brew machine, grinder device, milk frothing device, etc.) of the network environment 100, and shared from time to time among the devices so that one or more of the devices have the most recent data associated with the system. The types of data described herein are a few examples, and any type of data stored by the memory 406 should be considered within the scope of this disclosure.

The user interface 412 (which may be, for example, similar/identical to the interface 300) of the brew machine 200) may be configured to facilitate user access and control of the brew machine 400. The user interface 412 may include sliders, buttons, selectable objects, etc. such that interacting with the sliders, buttons, selectable objects, etc. may enable a user to initiate a brew, customize drink recipes by adjusting brew parameters, configure a user profile, configure the brew machine, send feedback, etc. Other user interfaces of varying formats, styles, and interactive sequences may alternatively be implemented on one or more brew machines to provide comparable control.

The one or more sensors 422 may comprise temperature sensor(s), a microphone, a measurement scale, and/or other sensors that can assist with the brewing process (including grinding beans), the user interface, troubleshooting, etc. of the brew machine 200.

The brewer assembly 410 may use any number of technologies for brewing such as, for example, centrifugal brewing, pressure-based brewing, percolate brewing, etc. Example centrifugal brewing machines include those described in U.S. Pat. Nos. 8,039,033, 10,863,855, and U.S. patent application Ser. No. 16/636,841, all of which are incorporated herein by reference.

The grinder assembly 408 may include, for example, a burr grinder that takes coffee beans as input from a bean hopper (e.g., bean hopper 202 of brew machine 200) and outputs ground coffee beans into a brewer assembly 410. Alternatively, an external grinder may be used to grind coffee beans which can be input into the brewer assembly 410.

The network interface 414 may be configured to facilitate a data flow between the brew machine 400 and one or more other devices on a data network. As such, the brew machine 400 may be configured to receive recipes over the data network from one or more other brew machines and/or processing devices in communication with the brew machine 400, a brew machine and/or processing device within a local area network, or a brew machine and/or processing device over a wide area network such as the Internet. In one example, the recipes and other signals transmitted and received by the brew machine 400 may be transmitted in the form of digital packet data containing an Internet Protocol (IP)-based source address and IP-based destination addresses. In such a case, the network interface 414 may be configured to parse the digital packet data such that the data destined for the brew machine 400 is properly received and processed by the brew machine 400.

As shown, the network interface 414 may include wireless interface(s) 416 and wired interface(s) 418. The wireless interface(s) 416 may provide network interface functions for the brew machine 400 to wirelessly communicate with other devices (e.g., other brew machine(s), external grinder(s), milk frothing component(s), processing devices(s), network storage device(s) within a data network the brew machine 200 is associated with) in accordance with a communication protocol (e.g., any wireless standard including IEEE 802.11a, 802.11b, 802.11g, 802.11n, 802.11ac, 802.15, 4G, 5G mobile communication standard, and so on). The wired interface(s) 418 may provide network interface functions for the brew machine 400 to communicate over a wired connection with other devices in accordance with a communication protocol (e.g., IEEE 802.3). While the network interface 414 shown in FIG. 4 includes both wireless interface(s) 416 and wired interface(s) 418, the network interface 414 may in some embodiments include only wireless interface(s) 416 or only wired interface(s) 418.

3. Example Control of the Brew Machine

A brew machine (e.g., the brew machine 200 that may be configured to be one or more of the brew machines 112, 116, 122 of the example network environment 100 of FIG. 1), may be controlled using a user interface (e.g., user interface 300 on the brew machine 200 or user interface 412 on the brew machine 400) and/or using a brewing application executing on a processing device such as, for example, processing devices 106, 108, 120, and 126. Example applications include a brewing application and a roasting application.

As an example, with reference to the network environment 100 of FIG. 1 and the user interface 300 of FIG. 3, the user 118 may control the brew machine 122 through the interface 300 on the brew machine 122 and/or using a brewing application running on the processing device 120. The user 118 may, for example, assign drink recipes to the configurable selectable items 304 of interface 300. The user 118 may also select an operating region for the brew machine 122 and provide other customized parameters (e.g., a preference of having drinks extra hot, a preference for having more concentrated drinks, etc.).

The user 118 may further identify a coffee bean/roast to be used for brewing in the brew machine 122. For example, a user may identify the coffee bean/roast by selecting the coffee bean/roast from among a list of supported coffee bean/roast descriptors. In another example, the coffee bean/roast may be identified based on a purchased history of the user 118. The purchase history may be available remotely in the file storage 104 and/or may be available locally on the processing device 120. In another example, the user 118 may capture an image of a coffee bag and/or other identifying information of the bean/roast, e.g., using an imaging sensor (e.g., camera on the processing device 120) and/or a photo or video of the coffee bag or other identifying information together with an application running on the processing device 120 to identify the coffee bean/roast being used. In yet another example, the user 118 can manually enter (e.g., using the brewing application executed on the processing device 120) the information identifying the coffee bean/roast.

After the identification of the coffee bean/roast, drink recipes associated with the coffee bean/roast can be downloaded onto the brew machine 122 based on the identified coffee bean/roast. An example process flow may include: (i) the brewer application running on the processing device 120 transmitting a message to the remote processing device 106, the message including the identification of the coffee bean/roast and brew machine 122 to the remote processing device 106; (ii) the remote processing device 106 determining the one or more recipes using the identification of the coffee bean/roast and the brew machine 122; and (iii) the remote processing device 106 providing the recipes to the brew machine 122. In one example, the brew parameters can be determined using a classification of the beans such as a bean color (e.g., light, medium light, medium, medium dark, dark, etc.) and/or a bean size (e.g., small bean, medium bean, large bean, etc.). In another example, the brew parameters can be determined using the identified bean/roast (with potentially additional information such as the roast date, etc.).

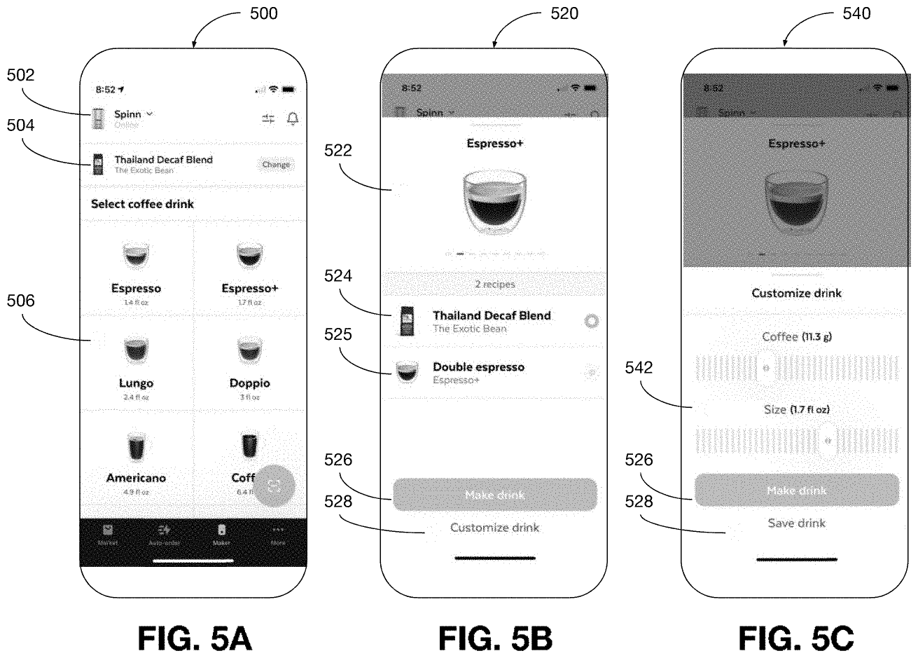

FIGS. 5A-5C depict example screens 500, 520, 540 of a brewing application executing on a processing device for controlling a brew machine, such as processing device 120 for controlling the brew machine 122. In an embodiment, the brewing application on the processing device 120 may control the brew machine 122 by communicating with the remote processing device 106 through the network 102. Based on the information received from the brewing application on the processing device 120, the remote processing device 106 may provide instructions to control the brew machine 122 by communicating with the brew machine 122. In another embodiment, the brewing application on the processing device 120 may control the brew machine 122 by directly communicating with the brew machine 122 (e.g., through a local communication protocol such as Bluetooth® or WiFi Direct®, through the LAN, etc.).

FIG. 5A depicts an example screen 500 that may allow a user to select a brew machine, to select a coffee bean to be used by the brew machine, and to select a coffee drink to be brewed through the selected brew machine. As shown in FIG. 5A, the example screen 500 provides a brew machine selection interface 502 that enables the user to select a brew machine (e.g., brew machine 122) and provides a status of the selected brew machine 122. The selection of the brew machine may include brew machines that are in the same physical space (e.g., determined by proximity sensors, wireless signal detection, etc.) as the user and/or brew machines that are in different physical locations from the user. The example screen 500 also provides a bean selection interface 504 that enables the user to view the currently selected coffee bean that is assigned to the brew machine and/or modify the assignment of the coffee bean to be used with the brew machine 122. In embodiments, once a bean is selected for a brew machine 122, one or more recipes associated with the coffee bean may be downloaded by the brew machine 122. The example screen 500 also provides a set of selectable drink options 506. The selectable options may include, for example, “Espresso,” “Espresso+,” “Lungo,” “Doppio,” “Americano,” “Coldbrew,” “Coffee,” “Mug,” “XL Bold,” “Carafe,” or other example specialty drinks. One or more of the drinks may also include instructions and/or videos that may be displayed on a screen of the processing device to show the user (e.g., through the brewer application) how to make the drink using the brew machine 122. For instance, the instructions may include, “place ice in a cup, and pour espresso shot over the ice,” for a cold espresso drink.

FIG. 5B depicts a second example screen 520 generated by the brewer application that is displayed on the processing device after a drink is selected. In this example, the screen 520 may be shown after the drink “Espresso+” was selected and includes a first drink selector 522, a second drink selector 525, a bean selector 524, a brew selector 526, and a custom drink selector 528. The first drink selector 522 displays the currently selected drink (e.g., Espresso+) and provides a mechanism (e.g., swipe left/right using a touchscreen interface) to change the drink selection. The bean selector 524 shows the currently selected coffee bean that is assigned to the brew machine 122, and can also be used to modify the selected bean. The second drink selector 525 may allow the user to select one of potentially many drink variations of the first drink selection. In this example, only a single drink variation “Double Espresso” is shown. Once the brew selector 526 is selected, the recipe may be updated on the brew machine 122 and the brew process is initiated.

As discussed above, the drink recipe may include parameters including the coffee bean, the roast, and specific details of the brew machine. Additionally, the recipe may consider location information of the brew machine which may be determined, for example, via user registration, reverse IP address look-up procedures, etc. For example, coffee drinks in Italy may vary from those served in the United States. The variations may be on the type of coffee drinks offered, ratio of water to coffee, amount of coffee, etc. The selectable drink options and corresponding recipes may therefore be different for different regions to accommodate these variations. For example, upon identification of the location information of the brew machine, a server (e.g., remote processing device) providing recipes to a brewing machine may select recipes (e.g., including drink options) associated with the identified location to provide to the brew machine. The recipes may also be based on the roaster. For example, roasters may have fine-tuned the brew parameters to emphasize particular flavors of specific coffee beans and/or coffee roasts, and/or the roasters may have their own specialty drinks. For example, upon identification of a particular roast/bean being used in a brew machine and/or the identification of a particular roaster the brew machine is identified with, a server (e.g., remote processing device) providing recipes to a brewing machine may select and provide recipes (e.g., including drink options) associated with the identified roast/bean and/or roaster to the brew machine. Therefore, the selectable drink options and corresponding recipes may be customized based on the roaster. The selectable drink options and corresponding recipes may also be based on coffee houses and/or other drink establishments and/or specialty baristas, which may have their own custom drinks and/or drink recipes. For example, a specialty barista may be selected as a recipe creator for a brew machine, and as a result of the selection, the default recipes and/or drinks provided on the brewing application for the brew machine are associated with the specialty barista. This enables users all over the world to connect and share recipes.

As an example, with reference to the network environment 100 of FIG. 1, the user 118 may control the brew machine 122 using a brewing application running on the processing device 120. An example process flow may include (i) the brewer application executing on the processing device 120 transmitting a message to a remote processing device 106, the message including the identification of the selected coffee bean, drink, and brew machine; (ii) after receiving the message from the processing device 120, the remote processing device 106 determining the recipe corresponding to the selected drink, coffee bean, and brew machine; (iii) the remote processing device 106 transmitting a message to the selected brew machine 122, the message including the determined recipe and a command for the selected brew machine 122 to start brewing the drink; (iv) after receiving the message from the remote processing device 106, the brew machine 122 updates the recipe for the drink and starts brewing the drink. Although this message flow is described using a remote processing device 106 to facilitate the communication between the brewing application on the processing device 120 and the brew machine 122, it is further contemplated that the actions/operations described with respect to the remote processing device 106 be executed by the processing device 120 without involving the remote processing device. Additionally, the above process flow may include the brew machine 122 transmitting a message to the grinder machine 128, the message including the determined recipe (or portion thereof that is relevant to the grinder machine 128) and a command for the grinder machine 128 to start grinding the beans. Alternatively, the above process flow may include the remote processing device 106 transmitting a message to a grinder device 128, the message including the determined recipe (or portion thereof that is relevant to the grinder machine 128) and a command for the grinder machine 128 to start grinding the beans.

Referring back to FIG. 5B, the custom drink selector 528 may be used by the user to further customize certain parameters of the drink recipe.

FIG. 5C depicts a third example screen 540 generated by the brewer application that is displayed on the processing device after the custom drink selector 528 of FIG. 5B is selected. In this example, the screen 540 includes a slider interface 542 corresponding to two custom parameters: coffee weight, and drink size. Although only two parameters are shown in FIG. 5C, additional parameters may be customized. The customized parameters may be saved as a recipe in the brew application for later use. Furthermore, the saved recipe (i.e., with customized parameters) may be assigned to the selectable items of the interface of a brew machine (e.g., selectable items 304 of the interface 300, as shown in FIG. 3).

In another example embodiment, a user may share (e.g., in a social network fashion) their customized settings for other users to download for their connected brewing machines. For example, a link that points to a file including the user's brewing settings may be provided. This can be used to share recipes, promote users as recipe creators, promote beans/roasts, among other things.

4. Example Brew Flow

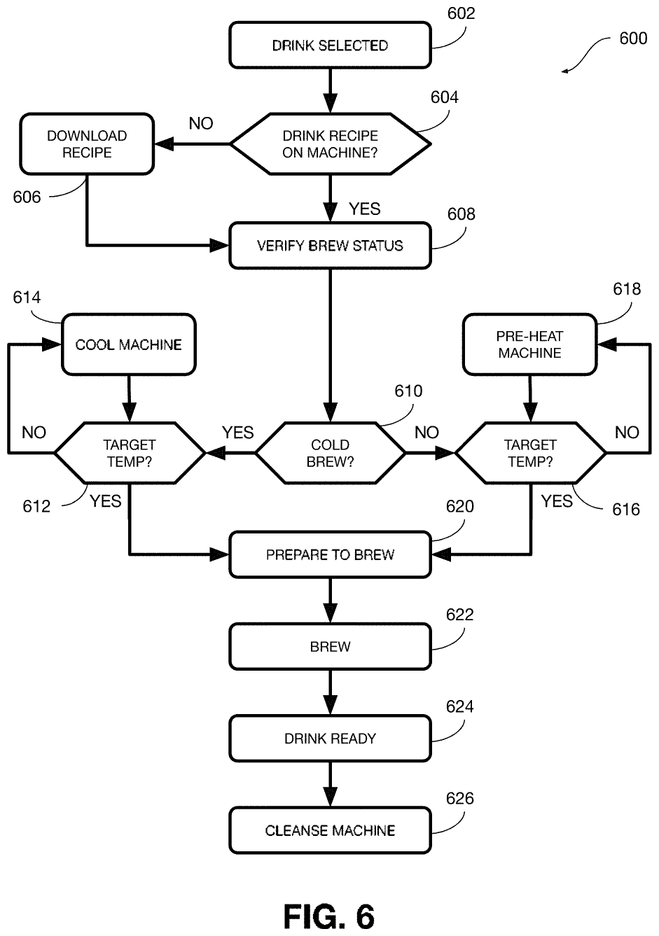

FIG. 6 depicts an example method 600 for brewing a selected drink, according to an example embodiment of the disclosure. The method 600 can be implemented by a brew machine (e.g., brew machines 112, 116, 122 shown in FIG. 1, brew machine 400 shown in FIG. 4) and/or one or more other processing devices (e.g., processing devices 108, 120, 126 and remote processing device 106 shown in FIG. 1). The method 600 can also be implemented by a brew machine in cooperation with a grinder machine (e.g., grinder machine 128 shown in FIG. 1). The method 600 may include one or more operations, functions, or actions as illustrated by one or more blocks. Although the blocks are illustrated in sequential order, these blocks may also be performed in parallel, and/or in a different order than those described herein. Also, the various blocks may be combined into fewer blocks, divided into additional blocks, and/or removed based upon the desired implementation.

In block 602 a drink is selected for brewing. For example, the drink may be selected using either (i) a brewer application that is executing on a processing device, which may further communicate with a brew machine to make the drink, or (ii) using an interface (e.g., interface 300 shown in FIG. 3) on the brew machine itself. If the selection is made using the brewer application, the user can customize a drink recipe (e.g., using a slider interface 542 shown in FIG. 5C) prior to selecting the drink recipe for brewing.

In block 604, a determination is made whether the recipe corresponding to the drink selection is already on the brew machine or if the brew machine needs to download the recipe. For example, if the drink selection was made using an application (e.g., brewing application) on a processing device, then the recipe may need to be downloaded onto the brew machine prior to brewing. If however, the drink selection was made using an interface on the brew machine (e.g., using interface 300 of FIG. 3), then a recipe stored on the brew machine may be used and the operation may proceed directly to block 608 to verify brew status without executing block 606.

In block 606, a recipe is downloaded onto the brew machine. In one example, the brewer application executing on a processing device transmits a message to a remote processing device, the message including a drink selection, a bean selection, a brew machine identifier (e.g., the brew machine identifier may be used to determine the make, model, revision, configuration and/or calibration parameters, etc.), configuration and/or calibration parameters, and the like. After receiving the message from the processing device, the remote processing device determines a recipe corresponding to the drink selection, the bean selection, the brew machine, configuration and/or calibration parameters, and the like. The recipe may be further modified based on parameters further configured by the user (e.g., through the sliders 542 as shown in FIG. 5C, or equivalent), and transmitted from the processing device to the remote processing device. The remote processing device then transmits a message to the brew machine, the message includes the recipe to make the selected drink. Additionally and/or alternatively, the processing device may determine the recipe and/or communicate directly with the brew machine without involving the remote processing device.

In block 608, the brew status may be verified (e.g., by the brew machine). The verification of brew status may include several different checks and operations. For example, the brew machine may verify there is enough water in the water reservoir tank to make the selected drink. A sensor on the brew machine can be used to detect the water level; based on the recipe of the drink selected (and taking into account the amount of water for cleaning), the brew machine may determine if there is enough water to make the drink. In some embodiments, there may be two or more sensors used to measure various water levels in the water reservoir tank. For example, when the water tank is filled, a HIGH level sensor is activated. A counter may then be used to determine how many big and small drinks may be made using the water level detected by the HIGH level sensor. When the water level reaches a LOW level sensor, the counter may be updated and a correction to the counter may be made (e.g., the number of drinks that may be made be significantly lower).

The verification of the brew status may further include verifying if there are enough coffee beans in the hopper to make the selected drink. For example, a sensor (e.g., infrared sensor, weight sensor/scale, optical camera, etc.) may be used to determine if there are enough beans to make the selected drink. For the sensors using mechanisms other than weight to make the sufficiency determination, a calculation may be made to approximate the amount of beans (e.g., in weight, volume, or count) that may be desired for the drink. This calculation may consider characteristics (e.g., water absorption, etc.) of the specific bean/roast.

The verification of the brew status may also include verifying that the drip tray has sufficient room to make the selected drink and/or is not full. In an embodiment, a drink counter may be used to estimate if the drip tray is full. The drink counter can be reset each time the drip tray is removed and reinserted. The drink counter may count each drink made and concomitantly estimate how much water is used for pre-heat, serving, post-flushing, cleaning, etc. for each drink made. Using the drink counter may therefore provide an estimate of the amount of water in the drip tray. Therefore, prior to starting a new drink, the drink counter may be checked to determine if there is enough room for the new drink. In another embodiment, a sensor located in/around the drip tray may be used to determine the water level in the drip tray. Based on the water level, a determination may be made whether there is enough room in the drip tray to make the selected drink, including the post-flushing and cleaning steps.

The verification of the brew status may further include verifying whether the residue container (that may store the spent coffee grounds) has enough room to make the selected drink and/or is not full. A sensor such as a weight sensor/scale measuring the calibrated residue container, an infrared sensor measuring the height of the spent coffee grounds, internal optical camera visually detecting the amount of spent coffee grounds may be used to determine if there is sufficient room in the residue container for the spent coffee grounds from the new drink after it is made.

The verification of the brew status may further include verifying whether there is a vessel (e.g., cup) located under the spout to receive the brewed drink. One or more sensors such as weight sensors, infrared sensors, camera sensors, etc. may be used to determine whether a vessel is present.

In block 610, a determination is made whether the selected drink will be brewed cold or hot. For example, the determination may be based on user input that is, for example, explicit (e.g., user selects “hot drink” vs “cold drink”) or implicit (e.g., user selects “cold brew” vs. “americano” or “espresso”), etc. In one example, the user input may be through a user interface on a processing device that is associated with (or connected to) the connected brew machine. In another example, the user input may be through an interface directly on the brew machine. If the selected drink is brewed cold, then block 612 is executed; else block 616 is executed.

In block 612, a determination is made if the temperature of the brewing system (e.g., temperature of components in the brewer assembly, ambient internal temperature of the brew machine, etc.) meets a target cold brew temperature. The target temperature for cold brew may be significantly below the target temperature for hot brew. In other words, there may be no overlap in target temperatures between the hot brew mode and the cold brew mode. If, in block 612, it is determined that the temperature of the brewing system is warmer than the target cold brew temperature, then a cooling procedure is invoked in block 614. Otherwise, the brewing system prepares to brew.

In block 616, a determination is made if the brewing system (e.g., temperature of components in the brewer assembly, ambient internal temperature of the brew machine, etc.) meets a target hot brew temperature. The target temperature for hot brew may be significantly above the target temperature for cold brew. In other words, there may be no overlap in target temperatures between the hot brew mode and the cold brew mode. If in block 616, it is determined that the temperature of the brewing system is cooler than the target hot brew temperature, then a heating procedure is invoked in block 618. Otherwise, the system prepares to brew.

In example embodiments, one or more temperature sensors in the brew machine (e.g., temperature sensors positioned on or near the gutter heating element, the water heating element, and/or top plate of the brewer assembly) are used to measure the temperature of the brewing components (e.g., gutter heating element, water heating element, etc.) and also to measure the ambient/internal temperature of the brew machine. These temperature measurements are performed in block 612 (for cold brew) and block 616 (for hot brew).

In an embodiment, a temperature sensor may be positioned on, inside, or near the flow-through heater to determine the approximate temperature of the brewer assembly. The sensor values measured by the temperature sensor may be stored in the firmware and may be used to determine if the brewer assembly needs to be heated or cooled. Additionally, the firmware may determine a target brew temperature based on the drink type and the temperature from the one or more temperature sensors. Other parameters may be modified based on the measured temperature(s). For example, depending on the temperature measurements, a higher/lower flow rate may be used (e.g., water at 10 degrees Celsius may need a lower flow rate than water at 24 degree Celsius).

In block 614, a cooling procedure is invoked to cool the brew machine until the brewing system is measured to be below the target cold brew temperature. For example, a target cold brew temperature for ambient temperature inside the brew machine is typically less than 75° C. However, it may not be uncommon for the internal ambient temperature inside the brew machine to be much higher than 75° C. when the machine is used for both hot and cold brew. In fact, cooling the brew machine down after a hot brew may take several hours without proper cooling procedures. In some examples, the target cold brew temperature is a brew parameter that is provided in the recipe.

Different types of cooling procedures may be used to cool the brew machine. For example, heating elements and/or other elements of the brew machine that generate heat may be turned off. Additionally one or more internal fans may be used to pull heat away from the machine. Additionally or alternatively, a brew machine using a centrifugal brewer assembly may be air cooled by spinning the brewer assembly while empty to pull air away from the brewing system. The brew machine may also use a water cooling procedure, by adding cold (i.e., unheated or chilled) water to the brewer assembly and spinning the centrifugal brewer assembly at a high rpm to spray the cold water to the different components. For hot environments, users may be asked to put ice water inside the water reservoir tank. The excess water may then be drained to the drip tray prior to brewing the cold brew.

In some embodiments, both water and air cooling may be applied simultaneously. For example, with reference to the brew machine in FIGS. 2C-2D, the water heating element 238 may be disabled (or turned off) so that the water remains cool, the gutter heating element 222 may be disabled (or turned off) so that the brewer assembly does not warm the water passing through to the spout, and the solenoid valve 236 is turned on such that the water can go to the brewer assembly. The water may be directed to the drip tray 208 through the drain 229 instead of through the spout 228 such that any water used for cooling is not directed to the vessel for the drink. The centrifugal machine may be then activated with a high speed (e.g., 4000 rpm) and a small amount of water (e.g., 50 ml) for a duration. At the end of each duration: (i) the level of water in the water tank may be checked to determine that there is sufficient water in the reservoir tank, (ii) the drip tray may be checked to determine it is not full, and (iii) the one or more temperature sensor(s) are checked to determine if the brewing system temperature is at or below the cold brew temperature. If the temperature is not yet at or below the cold brew temperature and there is sufficient water in the water tank and the drip tray is not full, the process is repeated for another duration. In some embodiments, the filter frame is lifted, and the spinning brewer 224 is used to pull air away from the inner surface of the brewer 224 further cooling the machine.

In block 616, a heating procedure is invoked to heat the brew machine until the brewing system is measured to be above the target hot brew temperature. For example, to achieve a preferred first-cup temperature between 75-80° C., the impact surfaces of the brewing system may be heated above that temperature.

In an example pre-heating procedure, the gutter heating element temperature may be determined using a temperature sensor placed at or around the gutter heating element. If, for example, the temperature of the gutter heating element is determined to be below 60° C., the gutter heating element can be operated in a BOOST mode by activating a 400 W heating element. If, however, the temperature of the gutter heating element is determined to be above 60° C. (which may be a standby temperature for hot drinks), the brew machine may be heated to a target hot brew temperature without the BOOST mode. In some examples, the target hot brew temperature is a brew parameter that is provided in the recipe.

In another example pre-heating procedure, the brew machine temperature may be determined using one or more temperature sensors described above. If, for example, the temperature of the brewing system is determined to be below the target hot brew temperature, water may be heated and passed through the empty brewer assembly to heat the system. For example, with reference to the brew machine in FIG. 2C-2D, the water heating element 238 may be turned on to heat the water, the gutter heating element 222 may be turned on so that brewer assembly heats the water passing through, and the solenoid valve 236 may be turned on such that the water can go to the brewer assembly. The water may be directed to the drip tray 208 through the drain 229 instead of through the spout 228 such that any water used for heating is not directed to the vessel for the drink. The amount of water that is pre-heated may be, for example 40 ml, 30 ml, or 20 ml. The higher the volume of water, the higher amount of pre-heat can be generated.

In block 620, after the measured temperature meets the target hot/cold brew temperature, a preparation may be made (e.g., by the brew machine) for brewing. The preparation procedures may be specific to the selected drink recipe. In one example, the preparation procedures may include grinding coffee beans. Depending on the selected recipe, a different measure (or weight) of ground beans may be desired. Once the beans are ground, they may be moved into the brewer assembly and pre-moistened. For cold brews, the water used for the pre-moisten process is cold, and a finer grind (compared to traditional non-espresso hot brew drinks) may be desired. For example, using a burr-grinder and centrifugal brewer assembly, the coffee beans may be ground to approximately 200-400 microns for a cold brew (similar to espresso), compared to a spectrum of approximately 400-1200 microns for hot brews. This is because cold water may need a larger surface area to extract the coffee flavor and therefore finer grounds are more suitable for cold brew. This unusually-small particle size would not be compatible with filters traditionally used for cold brew. The ground coffee may be tamped against a filter (e.g., with ˜200 micron holes) in the brewer (e.g., with centrifugal force of spin 4000 rpm), wherein the tamping pressure may be specific to the drink and/or coffee beans/roast, and may be dictated by the brew parameters in the recipe.

In block 622, the drink may be brewed (e.g., by the brew machine). Based on the recipe, a measured amount of hot/cold water is used for a specified duration of time for proper coffee extraction. For a hot brewed beverage, the water supplied to the brewing chamber and elements of the brewing assembly are heated during the brewing process (e.g., as described in U.S. patent application Ser. No. 16/636,841 which is incorporated herein by reference in its entirety). For example, with reference to the brew machine in FIG. 2C-2D, the water heating element 238 may be enabled (or turned on), via a control element, to heat the water supplied to the brewing chamber 224 for pre-infusion and/or extraction. The gutter heating element 222 may also be enabled (or turned on), via a control element, to heat the brewed beverage as it makes its way from the brewer 224 to the spout 228 for delivery to an awaiting vessel. Additionally, other elements of the brewer 224 may be heated, for example, to eliminate condensation from forming during the process of expelling the coffee bed 1310 from the brewer after use. For a cold brewed beverage, the water supplied to the brewing chamber and elements of the brewing assembly are intentionally not heated during the brewing process. For example, with reference to the brew machine in FIGS. 2C-2D, the water heating element 238 and gutter heating element 222 are disabled (or turned off) via one or more control elements during the brewing process (e.g., during pre-infusion and/or extraction). Additionally, when cold water is used for brewing the coffee bed 1310 doesn't create condensation when expelled against non-heated elements, and additional elements of the brewer 224 that may be heated for a hot brewed beverage may not need to be heated for a cold brew beverage. Additional procedures may be performed for the cold brewed beverage such as, for example, increasing the water flow (e.g., 4-5 ml/sec), which may increase the pressure on the coffee bed in the brewer assembly. The increased pressure may improve the crema and provide a boost for coffee extraction. Furthermore, cool water (e.g., cooled by ice cubes in the water tank) may be used for pre-infusion and extraction steps. The brew machine may request the user (e.g., in the brewing application) to add ice cubes in the water tank and/or a selection of a cold water source (if available) may be used to supply the cool water.

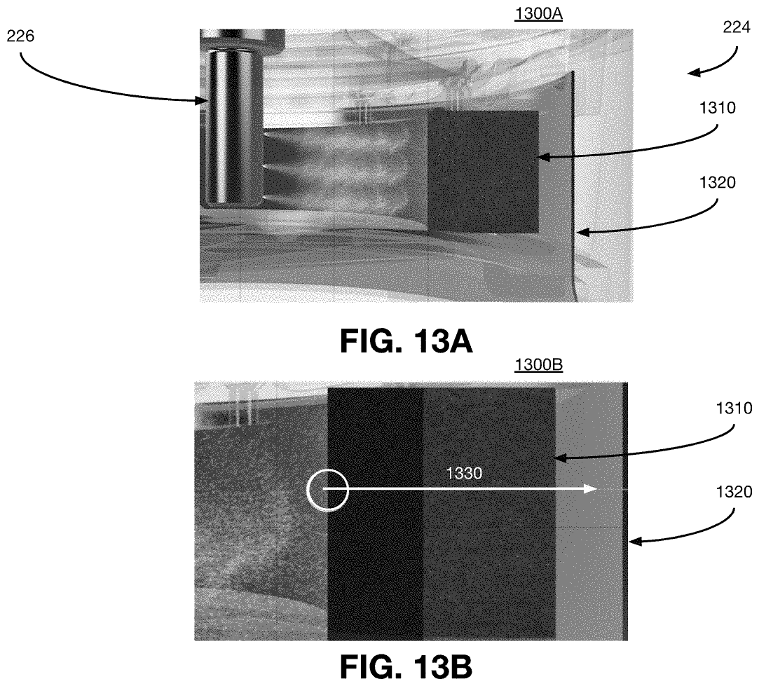

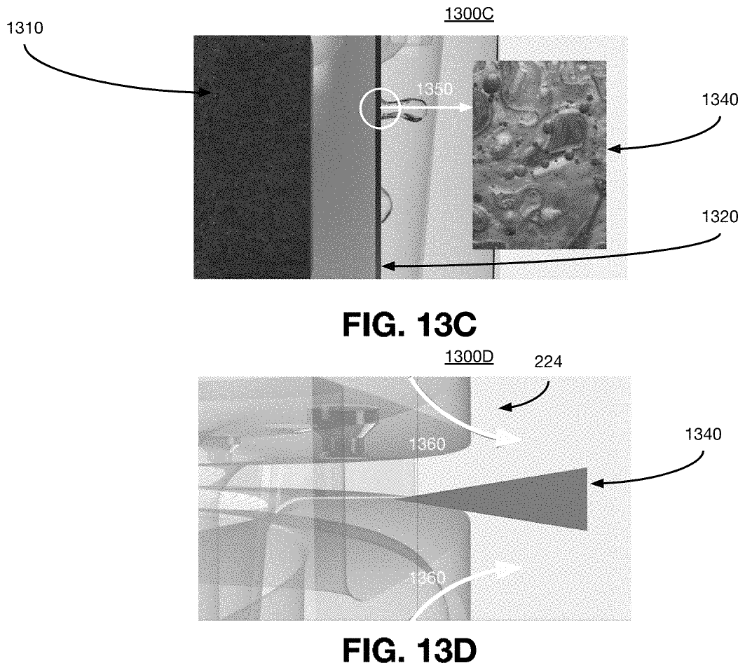

FIGS. 13A-13D illustrate process diagrams of a brewing process 1300, according to an example embodiment of the disclosure. As an example, the brewing process 1300 is described herein using the components of the centrifugal brew machine 200 shown in FIGS. 2A-2D. FIG. 13A illustrates a portion of the brewing process 1300A where a water inlet module 226 injects water into the brewer 224 toward a coffee bed 1310 (also referred to as coffee cake) which has been tamped against the filter 1320 (the tamping may be due to the centrifugal force from the spinning of the brewer 224). As the brewer 224 spins (e.g., with a centrifugal force of spin ˜2000-5000 rpm depending on the drink being brewed) water droplets, from the water inlet module 226, turn into a horizontal spray towards the spinning coffee bed 1310. FIG. 13B illustrates a portion of the brewing process 1300B where the coffee bed 1310 is being infused with the water due to the increased pressure from spinning the brewer 224. This is depicted by the arrow 1330 indicating the flow of water from the inner portion of the coffee bed 1310 (i.e., depicted darker in color to indicate that the inner portion of the coffee bed 1310 may be more saturated with water compared to the outer portions) toward the filter 1320. FIG. 13C illustrates a portion of the brewing process 1300C where the thick caramel colored liquid 1340 (e.g., consisting of water, dissolved coffee, oil) is forced from the coffee bed 1310 through the filter 1320. This is depicted by the arrow 1350 indicating the flow of water passing through the filter 1320. FIG. 13D illustrates a decanting step that may be used with the cold brew process to add bubbles to the brewed liquid to present a final cold brew liquid that may visually and texturally resembles that of a nitro cold brew beverage. This is because the liquid is turned into vapor droplets as it leaves the brewer and these droplets are infused with air to capture the oxygen in microscopic bubbles. This is depicted by the arrows 1360 indicating air injection mixing air with the extracted liquid 1340 exiting the brewer 224. It should however be understood that the decanting step is not necessarily limited to cold brew processes and similar decanting may be used for hot brew processes as well.

In block 624, an indication may be provided (e.g., by the brew machine) that the drink is ready. The indication may be visual (e.g., through an LED light) or audio (e.g., through a beep or voice notification).

In block 626, the brew machine is cleansed. Once the coffee extraction is complete in block 622, the coffee grounds are dried and expelled to the residue container. A cone heater may be used to heat the machine to expel the grinds. The lines may be cleaned, and the waste water may be drained to the drip tray.

For cold brews, additional cleaning procedures may be performed in the cleansing block 626. The cleaning procedures may be desired to add hot water and steam to the various parts of the brew machine to keep it mold free. However, the cleaning procedures may be invoked after a timer duration to avoid unnecessarily heating the machine when making several cold brew drinks. For example, 15 minutes after a cold brew, the gutter heating element can be turned on and the water is heated to 95° C. The heated water is flushed through the brewer assembly. A background drying mode may also be turned on and the brewer is rotated at a low rpm. The cleansing mode may be delayed so that it does not interfere with additional cold brews as the cleansing process involves heating steps that are counter to the cold brew process.

An optional block (not shown) allows a user to provide feedback on the drink. The feedback may be provided through the brewing application on a processing device (such as, for example, as simple as “thumbs up” or “thumbs down” or more complex such as “too watery,” “burnt flavor,” etc.) and/or using an interface on the brew machine. Depending on the feedback, the recipe may be changed (e.g., automatically by the remote computing device) and/or the feedback may be provided to the roaster.

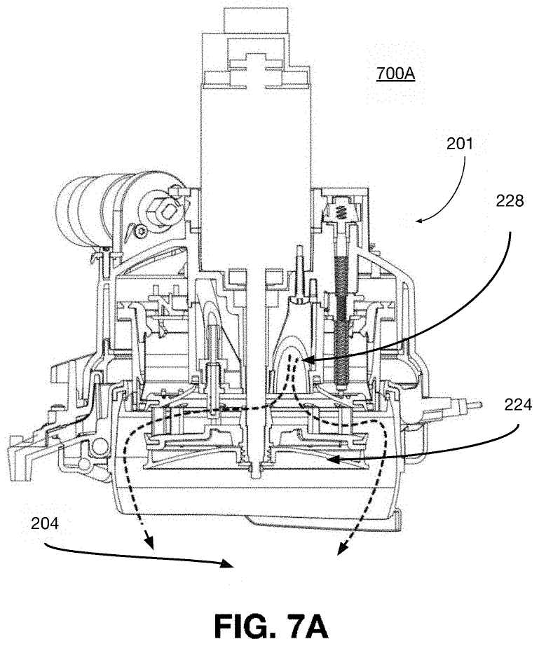

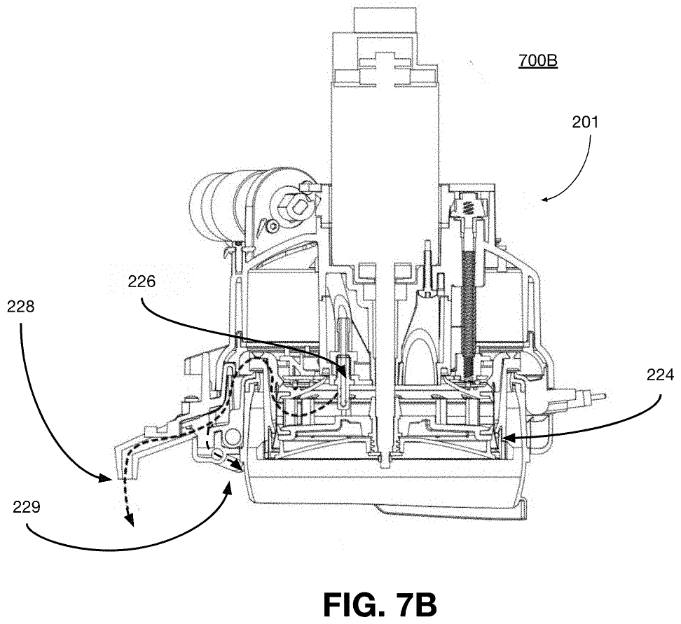

FIG. 7A illustrates a process diagram of a cooling process 700A, according to an example embodiment of the disclosure. As an example, the cooling process 700A is described herein using the components of the brew machine 200 shown in FIGS. 2A-2D. The cooling process 700A may use an airflow. For instance, ambient air (or compressed ambient air) may be conveyed from the bean hopper 202 through the grinder assembly 232 and transport tube 228 to the brewer 224 within the brew assembly 201, and then out to the residue container 204. Additionally or alternatively, the brewer 224 may be spun to aid the airflow from the bean hopper 202 through the grinder assembly 232 and transport tube 228 to the brewer 224 within the brew assembly 201, and then out to the residue container 204. In some embodiments a dedicated airflow pathway (not shown) is provided to facilitate airflow while avoiding unnecessary airflow through the hopper/transport tube. This may provide the benefit of avoiding airflow through a “bean pathway” (i.e., bean hopper, grinder, transport tube) to avoid unnecessary oxidation of the beans. The airflow shown in FIG. 7A is just one example, and any airflow path through the brew machine 200 should be considered within the scope of this disclosure.

FIG. 7B illustrates a process diagram of a cooling process 700B, according to an example embodiment of the disclosure. As an example, the cooling process 700B is described herein using the components of the brew machine 200 shown in FIGS. 2A-2D. The cooling process 700B may use water flow. For instance, cold water (e.g., with the room temperature water, chilled water, iced water in the water reservoir tank 206, etc.) may be sprayed on or otherwise provided to components of the brew assembly 201 through the water inlet 226. When the water is sprayed into the brewer 224, the brewer 224 may be rotated such that the sprayed water may circulate throughout the brew assembly 201. After the circulation, the water may be directed to the drip tray 208 through the drain 229 instead of through the spout 228 such that any water used for cooling is not directed to the vessel for the drink.

The aforementioned cooling processes 700A and 700B are just but a few examples of cooling the internal components of a brew machine. It should be understood that any kind of cooling mechanism, e.g., through mechanical actuation or chemical process, should be considered within the scope of this disclosure.

5. Example Roaster Flow

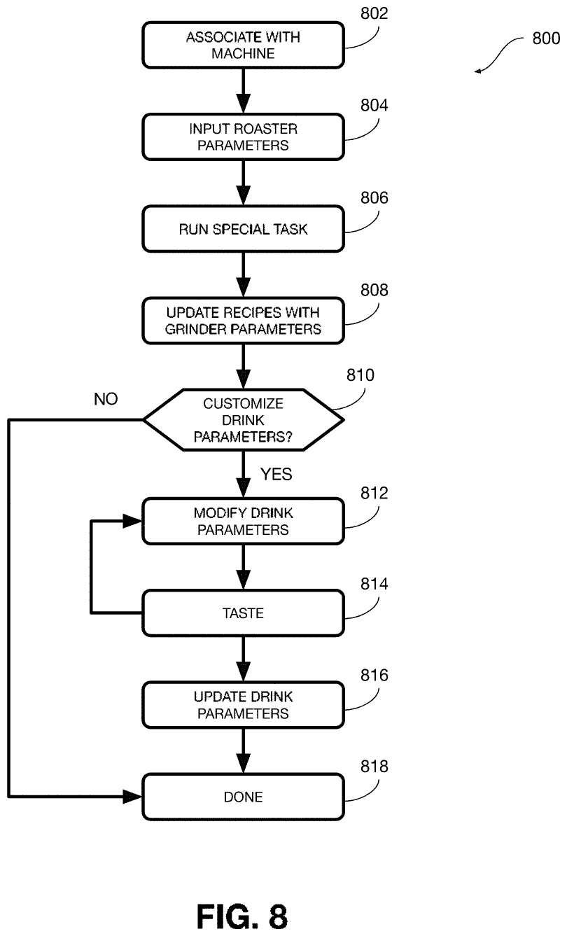

FIG. 8 depicts an example method 800 for using a roaster application to create a brewing recipe that can be distributed to connected brew machines, according to an example embodiment of the disclosure. The method 800 can be implemented using a roaster application executing on a processing device such as, for example, a processing device 108 associated with the roaster 110. Furthermore, the roaster application executing on a processing device may communicate with a brew machine (e.g., brew machine 112 of FIG. 1, brew machine 400 of FIG. 4), a grinder machine (e.g., grinder machine 128 of FIG. 1), a remote processing device (e.g., remote processing device 106), and/or any other components of the network environment 100 shown in FIG. 1. The method 800 may include one or more operations, functions, or actions as illustrated by one or more blocks. Although the blocks are illustrated in sequential order, these blocks may also be performed in parallel, and/or in a different order than those described herein. Also, the various blocks may be combined into fewer blocks, divided into additional blocks, and/or removed based upon the desired implementation.

In block 802, the roaster application executing on a processing device may be associated with a brew machine. In some embodiments, the roaster application communicates with a remote processing device, which in turn communicates with the brew machine. In other embodiments, the roaster application may communicate directly with the brew machine through local wireless communication protocols such as, for example, Bluetooth, Wi-Fi, and/or Zigbee®.

In block 804, bean/roast parameters are input using the roaster application. For example, the roaster application may render an interface to receive the roaster parameters.

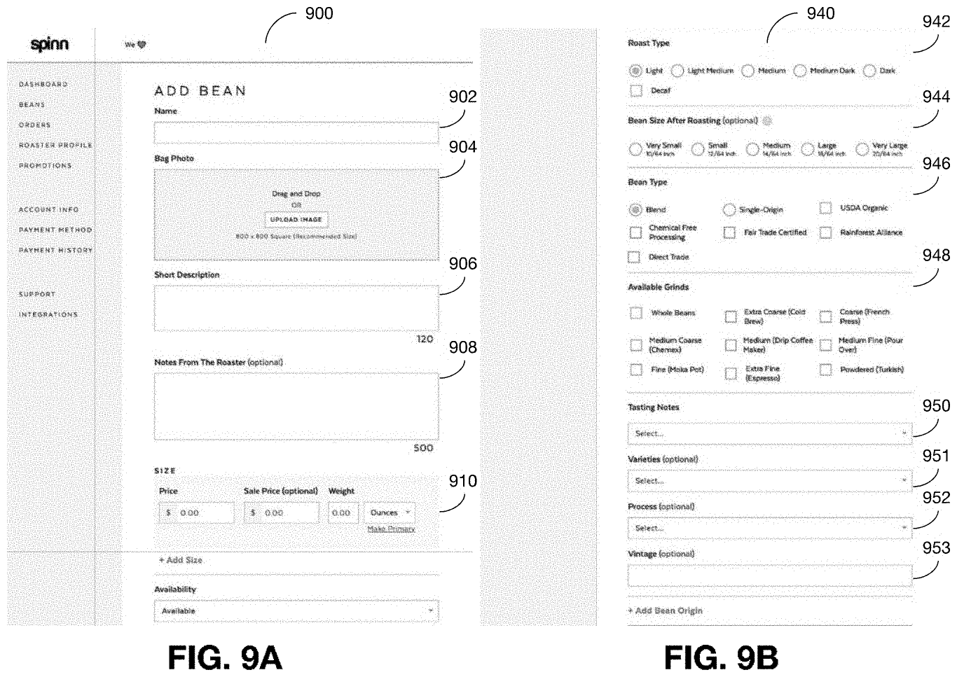

FIGS. 9A-9B depict example screens 900 and 940 for a roaster application to receive information about the bean and the roast. The screens 900 and 940 may be displayed on a processing device (e.g., processing device 108 of the example network environment 100 of FIG. 1) and comprise a number of software interfaces from which the roaster may provide information about the bean and the roast. For example, FIG. 9A depicts an interface designed to collect information that may be used for an online marketplace to sell the beans. Some example information that may be collected includes the bean name 902, a photo of a bag of beans 904, a brief description about the beans 906, additional notes from the roaster 908, and various information 910 about the price, weight, etc. of the bag of beans to be sold in the marketplace. FIG. 9B includes additional information about the bean type and roast that may be used to create an initial recipe. For example, some information that may be collected includes roast type 942 (e.g., light, light/medium, medium, medium/dark, dark, or decaf), bean size 944 (e.g., very small-10/64 inch, small-12/64 inch, medium 14/64, large 18/64, or very large-20/64 in), bean type 946 (e.g., blend, single-origin, USDA organic, chemical free processing, fair trade certified, rainforest alliance, or direct trade), available grinds 948 (e.g., whole beans, extra coarse, coarse, medium coarse, medium, medium fine, fine, extra fine, or powdered), tasting notes 950, varieties 951, process 952, or vintage 953.

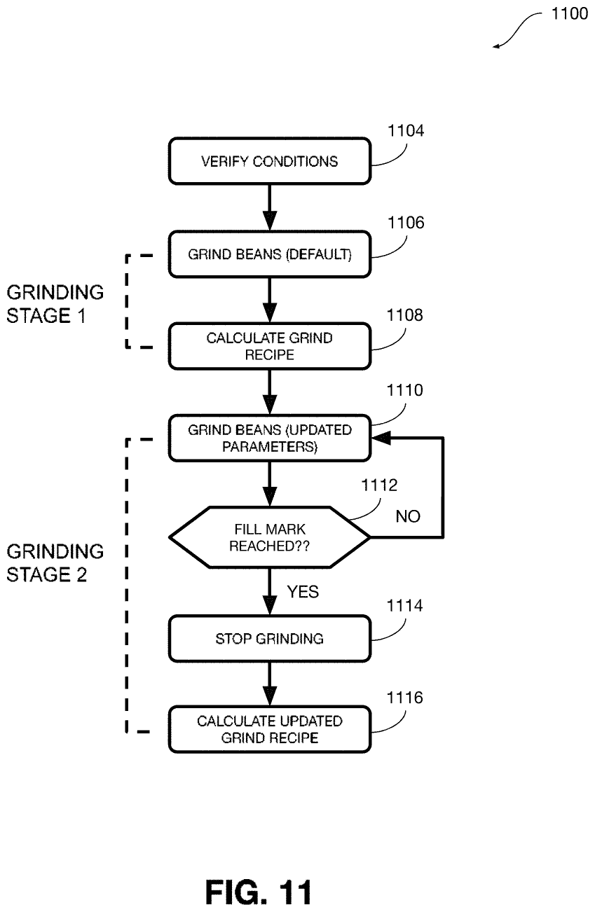

In block 806, a special task may be run to calibrate the grinder assembly for the corresponding bean/roast and produce a set of grinder parameters that characterize the bean/roast and can be used as input to recipes. An illustrative method incorporating the special task is shown in FIG. 11 and described in more detail below.

In block 808, drink recipes are updated with the grinder parameters determined during the special task. The grinder parameters are associated with the bean/roast name 902, photo 904, vintage 953, and other identifying information provided by the roaster. Once the grinder parameters are determined and the recipes are updated to reflect the parameters, the grinder parameters, recipes, and identifying information for each bean/roast may be sent from the brew machine to a remote processing device so they can be distributed to connected brew machines and/or connected grinder machines. It is also conceived that the grinder parameters, recipes, and/or identifying information for each bean/roast may be sent from the brew machine to another brew machine directly and/or to a grinder machine directly.

In block 810, a check is done whether the roaster wants to further customize any of the drink parameters. If the roaster does not want to further customize any drink parameters, block 818 is executed to conclude the method 800. If however, the roaster wants to further customize one or more drink parameters, block 812 is executed.

In block 812, the roaster application provides one or more interfaces for the user to customize the drink parameters.

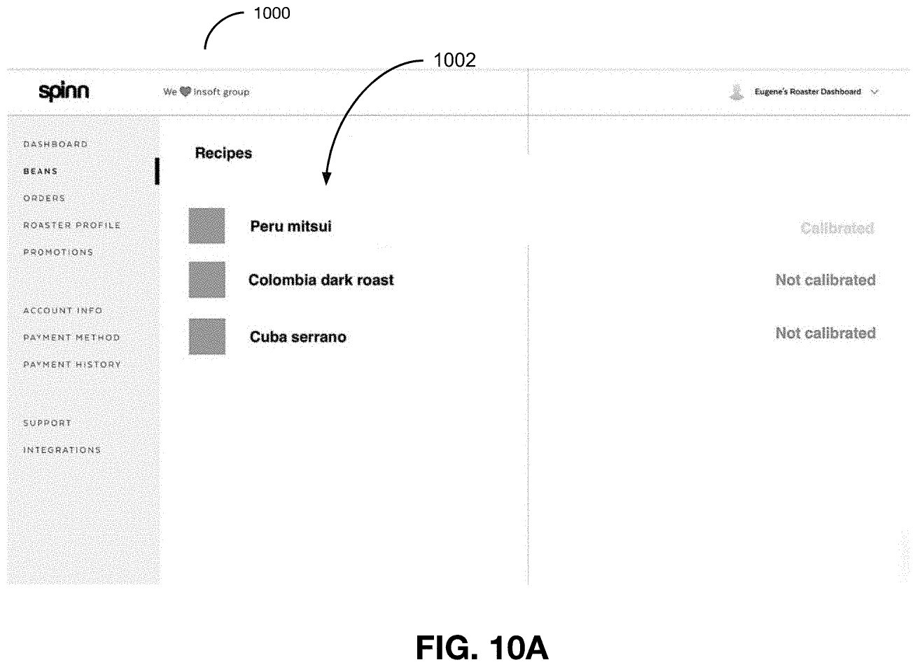

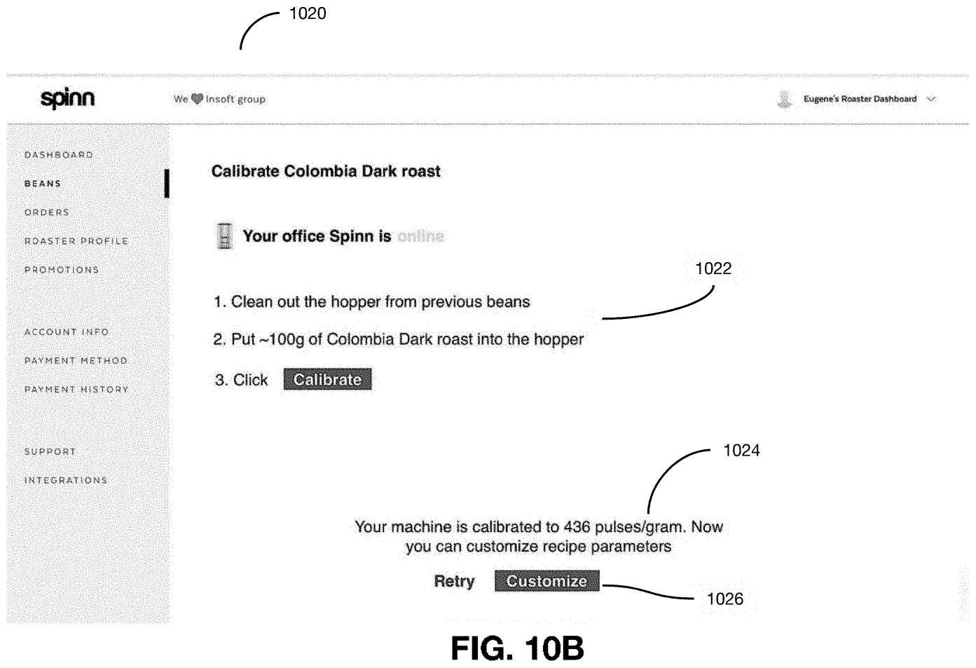

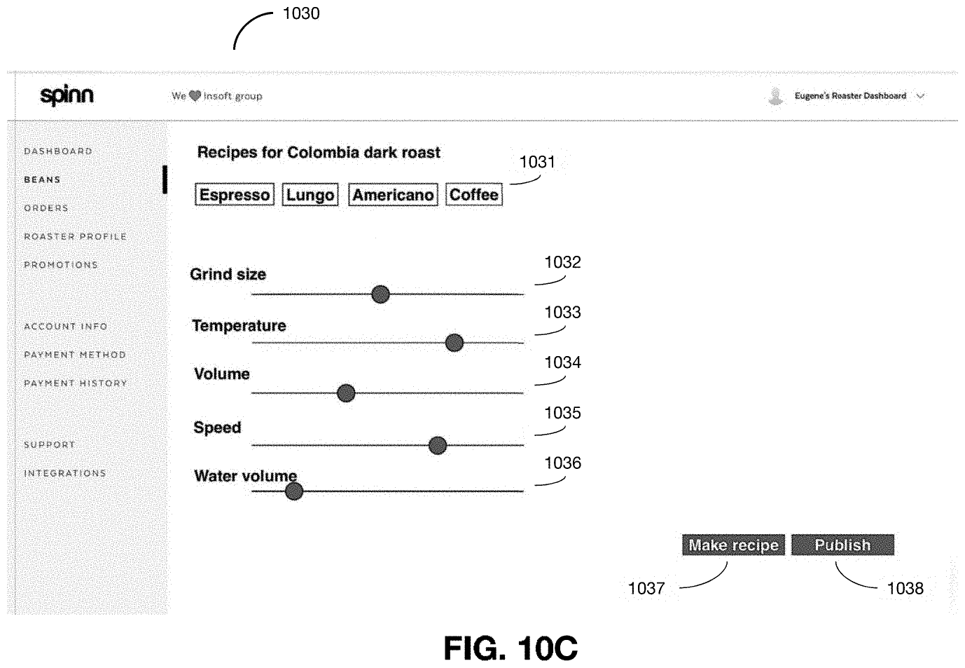

FIGS. 10A-10C depict example screens 1000, 1020, and 1030, respectively, to allow a roaster to customize drink parameters associated with one or more bean/roast combinations. The screens 1000, 1020 and 1030 may include one or more selectable elements to enable a roaster to customize one or more recipes. For instance, example screen 1000 shows a list 1002 of approved roaster beans that a roaster may select to generate or customize a recipe for. When the roaster selects an approved bean, screen 1020 may be generated, which may allow the roaster to calibrate a brew machine for the selected bean. For example, the screen 1020 may display instructions 1022 for the roaster to start the calibration of the brew machine. When the roaster follows the instructions and selects a “calibrate” command in the instructions 1022, a remote processing device may transmit a message to the brew machine to start a calibration process (e.g., using a special task described below in association with FIG. 11). After the brew machine performs the calibration process to generate an optimal number of electrical pulses per weight (e.g., pulses/gram) for the selected bean, the generated optimal number of pulses may be transmitted back to the remote processing device, which may cause the screen 1020 to display the calibration result in a message 1024. Within the calibration result message 1024, the screen 1020 may provide an option 1026 for customizing the recipe for the selected bean.

The display 1030 may be generated, for example, if the roaster selects the option 1026 for customizing the recipe in display 1020. The display 1030 may allow a customization of drink parameters. In an embodiment, the drink parameters that may be customized include but are not limited to: drink type 1031, grind size 1032, temperature 1033, grind volume 1034, tamping speed 1035, water volume 1036, etc. Additional drink parameters that may be customized (not shown in the screen 1030) may include cup size, pre-moist water volume, water volume after tamping, brew speed welling, welling time, extraction volume, extraction speed, amount of water added to the drink (e.g., for an Americano), ratio of water to coffee (e.g., in an Americano), etc. Once a recipe is modified using the roaster app (e.g., through the screen 1030) and/or any other type of mechanism, the recipe is sent from the roaster app to the brew machine to be brewed and analyzed. For example, the roaster may select a “make recipe” button on the display 1030.

In block 814, the brew machine brews a drink with the modified recipe that was customized in block 812 and the resulting drink is analyzed. In some embodiments, the drink analysis includes subjective analysis by the roaster and/or objective analysis by the brew machine. For example, the roaster may evaluate the drink by taste, color, texture, temperature, etc. In another example, the brew machine may evaluate the drink using various sensors included in the brew machine. For example, temperature sensors may be used to determine if the brew was too hot/cold. In another example, image sensors using image processing may be used to determine the color and/or texture of the drink. The process of modifying the parameters (block 814) and evaluating the results (block 816) may be repeated until a satisfactory recipe is created.

In block 818, the drink recipe is updated with the modified parameters. The updated recipe may be finalized and uploaded to the remote processing device, for example, by the roaster selecting the “publish” button 1038 in the display 1030 shown in FIG. 10C. Alternatively, the “publish” button 1038

FIG. 11 depicts an example method 1100 for using a special task (e.g., special task associated with block 806 of method 800) to determine the grinder parameters for a particular bean/roast. The method 800 can be implemented by a brew machine (e.g., brew machine 112, as shown in FIG. 1) in association with a roaster application (e.g., a roaster application executing in the processing device 108, as shown in FIG. 1), a remote processing device (e.g., a remote processing device 106, as shown in FIG. 1), and/or any other component within the network environment 100 shown in FIG. 1. Additionally and/or alternatively, the method 800 can be implemented by a connected grinder (e.g., grinder machine 128, as shown in FIG. 1) that is separate from a brew machine, in association with a roaster application (e.g., a roaster application executing in the processing device 108, as shown in FIG. 1), a remote processing device (e.g., a remote processing device 106, as shown in FIG. 1), and/or any other component within the network environment 100 shown in FIG. 1. The method 1100 may include one or more operations, functions, or actions as illustrated by one or more blocks. Although the blocks are illustrated in sequential order, these blocks may also be performed in parallel, and/or in a different order than those described herein. Also, the various blocks may be combined into fewer blocks, divided into additional blocks, and/or removed based upon the desired implementation.

In block 1104, the grinder assembly conditions are verified for the brew machine. This verification may include, for example, verifying that there are enough coffee beans in the hopper for a standard calibration grind. For example, a sensor (e.g., an infrared sensor, a weight sensor/scale, an internal optical camera, etc.) may be used to determine if there are enough beans in the hopper for calibration purposes.

In block 1106, the first grinding stage is used to determine, for a particular bean/roast, the yield or amount (e.g., weight) of beans that are ground based on a default yield calibration of the grinder assembly (e.g., using a reference bean and a grind setting established at the factory). For example, the brew machine grinds the coffee beans using default yield calibration parameters of the grinder assembly, which includes a grinder assembly distance (e.g., distance between two burrs in a burr grinder) and grinding time. The default yield calibration parameters may be established for each brew machine in a controlled environment (such as, for example, at the brew machine manufacturing facility) and using reference beans to calibrate the default yield. Once determined, the default yield calibration parameters for a machine can be stored in memory on the machine and/or on a remote processing device with a reference to the machine. When the first grinding stage is complete, the amount of coffee that was ground may be measured (e.g., weighed) and compared with the default yield to determine the grind parameters for the particular bean/roast. For example, if the grind yield was greater than the default yield, then the grinder parameter corresponding to the distance between the two burr grinders may be decreased. An example of the first grinding stage based on the default yield calibration may include the following operations: (i) the residue container may be calibrated by measuring the weight before the process begins; (ii) beans may be ground as part of the special task; (iii) the weight of the residue container may be measured after the grounds have been expelled into the residue container; (iv) the yield may be determined as the difference between the measured weight of the residue container after the calibration grind subtracting the measured weight before the calibration grind; and (v) the yield may be stored for the particular bean/roast. Another example of the first grinding stage based on the default yield calibration may include the following operations executed by a processor on the brewing device such as processor 402 on brew machine 400 in FIG. 4: (i) a first weight calibration procedure may be initiated by taring an internal scale used to measure the weight of the ground beans; (ii) beans may be ground as part of the special task; (iii) a weight measurement may be made of the ground beans using the internal scale to determine the yield; (iv) the yield may be stored for the particular bean/roast.

In block 1108, based on the grinder yield, a grind recipe may be determined for the particular bean/roast. In other words, grinding parameters for the recipe may be determined by the brew machine. For example, by comparing the grinder yield for the particular bean/roast with the default yield of a reference bean/roast that was previously calibrated at the factory, new grinder parameters can be determined for the particular bean/roast. For instance, the grind recipe may be based on the default yield calibration performed in step 1106. The default yield may correspond to other drink parameters, e.g., a temperature, ratio of coffee to water, and these parameters may be downloaded from a remote processing device to determine the grind recipe. This recipe may be modified during and after the second grinding stage, as described below.

In block 1110, the brew machine and/or grinder machine may enter a second grinding stage, using the updated grinder parameters. The second grinding stage is used to determine the grinder assembly parameters (e.g., electric pulses of a stepper motor, grind time, etc.) for the particular bean/roast to produce a fixed amount of ground coffee. These parameters can be used to determine the maximum amount (i.e., weight) of coffee that can be used with the machine. In this step, the grinder assembly grinds the beans until an internal fill mark is reached. In one example embodiment, the determination of when the ground beans have reached the fixed amount may be determined using a sensor in the brewer assembly. For example, a resistance measurement inside the brewer (e.g., brewer 224 of FIG. 2C) is used to determine if the ground beans have reached the fixed amount. In some embodiments, the fixed amount is also the maximum allowed amount of ground beans in the brewer assembly.

In block 1112, it may be determined that the internal fill mark is reached. For instance, the sensor may determine that the internal fill mark is reached, thereby indicating a maximum volume of the brew machine.

In block 1114, the grinder assembly stops grinding beans, in response to determining that the internal fill mark has been reached in block 1112.

At block 1116, the brew machine determines one or more updated grind parameters based on the time taken to grind the beans to the fill mark, and based on the updated grind parameters, the brew machine may calculate updated recipes for the beans. The updated recipes may be stored, for example, in a remote server/database, in association with the particular bean/roast such that the parameters may be downloaded to other brew machines that use these beans.

Once the grind parameters are determined for a bean, the maximum amount of coffee that can be supported in the brew machine can be determined, and can be used to auto-configure customizable values for the maximum coffee that can be used for all drinks using this bean/roast.

6. Example Processing Device

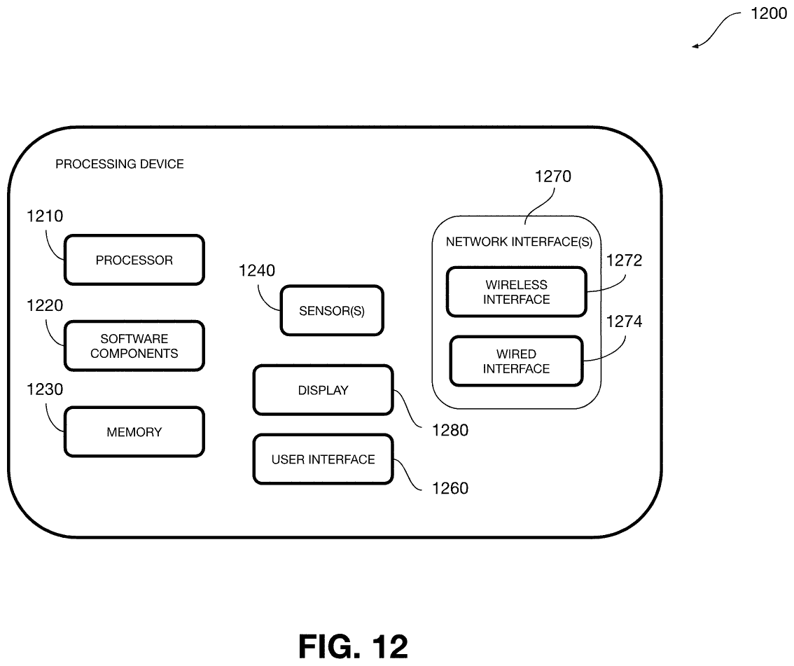

FIG. 12 shows a functional block diagram of an example processing device 1200 that can implement at least portions of the previously described methods 600, 800, and 1100. The processing device 1200 includes one or more processors 1210, software components 1220, memory 1230, one or more sensor inputs 1240, a user interface 1260, a network interface 1270 including wireless interface(s) 1272 and/or wired interface(s) 1274, and a display 1280.

In some examples, the one or more processors 1210 include one or more clock-driven computing components configured to process input data according to instructions stored in the memory 1230. The memory 1230 may be a tangible, non-transitory computer-readable medium configured to store instructions executable by the one or more processors 1210. For instance, the memory 1230 may be data storage that can be loaded with one or more of the software components 1220 executable by the one or more processors 1210 to achieve certain functions. In one example, the functions may involve the processing device 1200 retrieving recipes from a brew machine or another processing device. In another example, the functions may involve the processing device 1200 sending recipes to another device or a brew machine on a network.

The network interface 1270 may be configured to facilitate a data flow between the processing device 1200 and one or more other devices on a data network, including but not limited to data to/from other processing devices, brew machines, storage devices, and the like. As such, the processing device 1200 may be configured to transmit and receive recipes over the data network from one or more other devices in communication with the processing device 1200, network devices within a local area network (LAN), or brew machines over a wide area network (WAN) such as the Internet. The processing device 1200 may also be configured to transmit and receive sensor input over the data network from one or more other devices in communication with the processing device 1200, network devices within a LAN or over a WAN such as the Internet.

As shown in FIG. 12, the network interface 1270 may include wireless interface(s) 1272 and wired interface(s) 1274. The wireless interface(s) 1272 may provide network interface functions for the processing device 1200 to wirelessly communicate with other devices in accordance with a communication protocol (e.g., any wireless standard including IEEE 802.11a/b/g/n/ac, 802.15, 4G, 5G mobile communication standard, and so on). The wired interface(s) 1274 may provide network interface functions for the processing device 1200 to communicate over a wired connection with other devices in accordance with a communication protocol (e.g., IEEE 802.3). While the network interface 1270 shown in FIG. 12 includes both wireless interface(s) 1272 and wired interface(s) 1274, the network interface 1270 may in some embodiments include only wireless interface(s) 1272 or only wired interface(s) 1274.

The processing device may include one or more sensor(s) 1240. The sensors 1240 may include, for example, inertial sensors (e.g., accelerometer, gyrometer, and magnetometer), a microphone, a camera, etc.

The user interface 1260 and display 1280 can be configured to facilitate user access and control of the processing device. Example user interface 1260 include a keyboard, touchscreen on a display, navigation device (e.g., mouse), etc.

Additional examples of the presently described method and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A beverage machine configured to selectively operate in a brew mode selected from a hot brew mode and a cold brew mode, the beverage machine comprising:
a temperature sensor;
a brewing component;
a processor; and
a tangible, non-transitory computer readable medium storing computer program instructions, that when executed by the processor, cause the beverage machine to perform operations, in the cold brew mode, comprising:
detecting, via the temperature sensor, a temperature of the brewing component;
determining that the temperature is above a cold brew target temperature;
causing a fluid circulation adjacent to the brewing component until the temperature reaches the cold brew target temperature; and
after the temperature reaches the cold brew target temperature, cold brewing a beverage using the brewing component at the cold brew target temperature.

2. The beverage machine of claim 1, wherein causing, by the computer program instructions when executed by the processor, the beverage machine to perform operations, in a brew selection mode, comprising:
receiving a selection of the beverage for brewing;
downloading a recipe for the beverage selected for brewing;
determining that the selected beverage is a cold brew; and
initiating the cold brew mode based on the determination that the selected beverage is a cold brew.

3. The beverage machine of claim 1, wherein causing, by the computer readable instructions when executed by the processor, the fluid circulation adjacent to the brewing component comprises spinning the brewing component.

4. The beverage machine of claim 1, wherein causing, by the computer readable instructions when executed by the processor, the fluid circulation adjacent to the brewing component comprises running water through the brewing component.

5. The beverage machine of claim 1, wherein cold brewing the beverage further comprises disabling a water heating element that operates on water supplied to the brewing component for pre-infusion and/or extraction of the beverage.

6. The beverage machine of claim 1, wherein causing, by the computer program instructions when executed by the processor, the beverage machine to perform operations, in the hot brew mode, comprising:
detecting, by the temperature sensor, the temperature of the brewing component;
determining that the temperature is below a hot brew target temperature;
heating the brewing and collecting components until the temperature reaches the hot brew target temperature; and
after the temperature reaches the hot brew temperature, hot brewing a second beverage using the brewing component at the hot brew target temperature.

7. The beverage machine of claim 6, wherein the cold brew target temperature is below the hot brew target temperature.

8. The beverage machine of claim 6, wherein hot brewing a beverage further comprises enabling a water heating element that operates on water supplied to the brewing component for pre-infusion and/or extraction of the beverage.

9. The beverage machine of claim 1, wherein causing, by the computer program instructions when executed by the processor, the beverage machine to perform operations, in a cleaning mode after the cold brew mode, comprising:
determining that a time duration has exceeded a pre-determined value after the last beverage was brewed on the beverage machine;
detecting, by the temperature sensor, the temperature of the brewing component;
determining that the temperature is below a cleaning target temperature;
heating the brewing component until the temperature reaches the cleaning target temperature; and
running water through the brewing component at the cleaning target temperature.

10. The beverage machine of claim 1, wherein causing, by the computer program instructions when executed by the processor, the beverage machine to perform operations, in the cold brew mode, comprising:
spinning the brewing component above 3,000 revolutions per minute.

11. A system comprising:
a temperature sensor;
a brewing component configured to selectively operate in a brew mode selected from a hot brew mode and a cold brew mode;
a processor; and
a tangible, non-transitory computer readable medium storing computer program instructions, that when executed by the processor, cause the system to perform operations, in the cold brew mode, comprising:
detecting, via the temperature sensor, a temperature of the brewing component;
determining that the temperature is above a cold brew target temperature;
causing a fluid circulation adjacent to the brewing component until the temperature reaches the cold brew target temperature; and
after the temperature reaches the cold brew target temperature, cold brewing a beverage using the brewing component at the cold brew target temperature.

12. The system of claim 11, further comprising a grinder machine configured to grind beans for the beverage responsive to receiving a message from the processor.

13. The system of claim 11, wherein the operations further comprise:
receiving, in a brew selection mode, a selection of the beverage for brewing;
downloading a recipe for the beverage selected for brewing;
determining that the selected beverage is a cold brew; and
initiating the cold brew mode based on the determination that the selected beverage is a cold brew.

14. The system of claim 11, wherein the operations further comprise:
detecting, by the temperature sensor in the hot brew mode, the temperature of the brewing component;
determining that the temperature is below a hot brew target temperature;
heating the brewing and collecting components until the temperature reaches the hot brew target temperature; and
after the temperature reaches the hot brew temperature, hot brewing a second beverage using the brewing component at the hot brew target temperature.

15. The system of claim 11, wherein the operations further comprise:
determining, in a cleaning mode after the cold brew mode, that a time duration has exceeded a pre-determined value after the last beverage was brewed;
detecting, by the temperature sensor, the temperature of the brewing component;
determining that the temperature is below a cleaning target temperature;
heating the brewing component until the temperature reaches the cleaning target temperature; and
running water through the brewing component at the cleaning target temperature.

16. A method implemented on a beverage machine, the method comprising:
in a cold brew mode, selected from a hot brew mode and the cold brew mode:
detecting, via a temperature sensor of the beverage machine, a temperature of a brewing component of the beverage machine;
determining that the temperature is above a cold brew target temperature;
causing a fluid circulation adjacent to the brewing component until the temperature reaches the cold brew target temperature; and
after the temperature reaches the cold brew target temperature, cold brewing a beverage using the brewing component at the cold brew target temperature.

17. The method of claim 16, further comprising:
in a brew selection mode:
receiving a selection of the beverage for brewing;
downloading a recipe for the beverage selected for brewing;
determining that the selected beverage is a cold brew; and
initiating the cold brew mode based on the determination that the selected beverage is a cold brew.

18. The method of claim 16, further comprising:
in the hot brew mode:
detecting, by the temperature sensor, the temperature of the brewing component;
determining that the temperature is below a hot brew target temperature;
heating the brewing and collecting components until the temperature reaches the hot brew target temperature; and
after the temperature reaches the hot brew temperature, hot brewing a second beverage using the brewing component at the hot brew target temperature.

19. The method of claim 18, wherein the cold brew target temperature is below the hot brew target temperature.

20. The method of claim 16, further comprising:
in a cleaning mode after the cold brew mode:
determining that a time duration has exceeded a pre-determined value after the last beverage was brewed on the beverage machine;
detecting, by the temperature sensor, the temperature of the brewing component;
determining that the temperature is below a cleaning target temperature;
heating the brewing component until the temperature reaches the cleaning target temperature; and
running water through the brewing component at the cleaning target temperature.
